(19) United States
(12) Patent Application Publication
(10) Pub. No.: US 2019/0271573 A1
(43) Pub. Date: Sep. 5, 2019

(54) DISPLACEMENT DETECTION APPARATUS AND LENS BARREL PROVIDED WITH THIS, AND IMAGING APPARATUS

(71) Applicant: CANON KABUSHIKI KAISHA, Tokyo (JP)

(72) Inventors: Hideomi Nakagami, Utsunomiya-shi (JP); Kaori Tomura, Inagi-shi (JP); Kazuhiro Noguchi, Utsunomiya-shi (JP)

(21) Appl. No.: 16/414,658

(22) Filed: May 16, 2019

Related U.S. Application Data
(63) Continuation of application No. PCT/JP2017/041698, filed on Nov. 20, 2017.

(30) Foreign Application Priority Data
Nov. 22, 2016 (JP) 2016-226712

(51) Int. Cl. G01D 5/241; H04N 5/225; G02B 7/02

(52) U.S. Cl. CPC G01D 5/2415; G02B 7/02; H04N 5/2254; H04N 5/2253

(57) ABSTRACT

A displacement detection apparatus according to the present invention includes a first electrode unit including a plurality of detection electrode groups and a second electrode unit including a plurality of second electrodes that is movable relatively with respect to the first electrode unit. The plurality of detection electrode groups include a first detection electrode group including a plurality of first detection electrodes and a second detection electrode group including a plurality of second detection electrodes. In a maximum output state, at least one second detection electrode among the plurality of second detection electrodes is arranged in a manner that a position of a center of the at least one second detection electrode is different from a position of a center of a first counter electrode.

### CROSS-REFERENCE TO RELATED APPLICATIONS

This application is a Continuation of International Patent Application No. PCT/JP2017/041698, filed Nov. 20, 2017, which claims the benefit of Japanese Patent Application No. 2016-226712, filed Nov. 22, 2016, both of which are hereby incorporated by reference herein in their entirety.

### TECHNICAL FIELD

The present invention relates to a displacement detection apparatus and a lens barrel provided with this, and an imaging apparatus such as a video camera or a digital still camera to which this lens barrel can be mounted.

### BACKGROUND ART

Up to now, a lens barrel described in PTL 1 has been known as a lens barrel having a so-called manual focus (MF) function for detecting a rotation of an operating ring by electric means and electrically driving a focusing lens in accordance with the rotation.

PTL 1 discloses the lens barrel that detects a passage of a plurality of slits (notches) arranged at a predetermined interval in a circumferential direction of a rotating operation unit by a pair of photo interrupters and detects a rotation direction and a rotation amount of the rotating operation unit on the basis of the detected signal. The lens barrel in PTL 1 realizes a manual focusing operation mode (MF function) by rotating a screw by a stepping motor in accordance with rotation information (rotation direction and rotation amount) of the rotating operation unit to be driven following a movement of a nut screwed to the screw.

### CITATION LIST

### Patent Literature

PTL 1 Japanese Patent Laid-Open No. 2012-255899

Incidentally, to realize the MF function, the lens barrel in PTL 1 detects the rotation of the rotating operation unit by a configuration of a non-contact system using the pair of photo interrupters. For this reason, the photo interrupters require relatively high power consumption.

In view of the above, the present invention is aimed at providing a displacement detection apparatus in which power consumption is lower than before and a lens barrel using this, and an imaging apparatus.

### SUMMARY OF INVENTION

To achieve the above-described aim, there is provided a displacement detection apparatus according to the present invention, comprising:

a first electrode unit including a first detection electrode group including a plurality of first detection electrodes and a second detection electrode group having a phase difference of 180 degrees with respect to the first detection electrode group with regard to a predetermined periodic pattern and also including a plurality of second detection electrodes;

a second electrode unit having a predetermined periodic pattern and including a plurality of second electrodes that is movable relatively with respect to the first electrode unit;

a detection circuit configured to detect an electrostatic capacitance; and

signal processing means for detecting a displacement on the basis of an electrostatic capacitance between the first detection electrode group and the second electrode unit, and an electrostatic capacitance between the second detection electrode group and the second electrode unit, the displacement detection apparatus being characterized in that,

when a state in which an area where the first detection electrode group and the second electrode unit are overlapped with each other becomes the largest is set as a maximum output state,

in the maximum output state, an area where a region in which the first detection electrode group is arranged is overlapped with the second electrode unit is larger than an area where a region in which the second detection electrode group is arranged is overlapped with the second electrode unit,

in the maximum output state, when an electrode facing the region in which the second detection electrode group is arranged among the plurality of second electrodes is set as a first counter electrode,

at least one second detection electrode among the plurality of second detection electrodes is arranged in a manner that a position of a center of the at least one second detection electrode is different from a position of a center of the first counter electrode,

the predetermined periodic pattern of the second electrode unit is a repetitive pattern having a predetermined period in a predetermined direction,

the first electrode unit further includes a reference electrode unit having a length of an integral multiple of the predetermined period in the predetermined direction and being connected to ground, and

the second electrode unit is movable relatively with respect to the detection circuit.

Further features of the present invention will become apparent from the following description of exemplary embodiments with reference to the attached drawings.

### BRIEF DESCRIPTION OF DRAWINGS

FIG. 1 is a block diagram of an imaging apparatus according to respective embodiments.

FIG. 2A is a configuration diagram of an interchangeable lens according to a first embodiment.

FIG. 2B is a configuration diagram of the interchangeable lens according to the first embodiment.

FIG. 3A is an exploded perspective view of a movable electrode and a fixed electrode according to the first embodiment.

FIG. 3B is an exploded perspective view of the movable electrode and the fixed electrode according to the first embodiment.

FIG. 4A is a detailed diagram of the movable electrode and the fixed electrode according to the first embodiment.

FIG. 4B is a detailed diagram of the movable electrode and the fixed electrode according to the first embodiment.

FIG. 4C is a detailed diagram of the movable electrode and the fixed electrode according to the first embodiment.

FIG. 4D is a detailed diagram of the movable electrode and the fixed electrode according to the first embodiment.

FIG. 5 is a relationship diagram between the fixed electrode and the movable electrode according to the first embodiment.

FIG. 6A is a schematic diagram of an electric field shape formed between the fixed electrode and the movable electrode according to the first embodiment.

FIG. 6B is a schematic diagram of the electric field shape formed between the fixed electrode and the movable electrode according to the first embodiment.

FIG. 7 is an equivalent circuit diagram of the fixed electrode and the movable electrode and a signal processing block diagram according to the first embodiment.

FIG. 8 is a graphic representation illustrating a signal based on an electrostatic capacitance formed by the fixed electrode and the movable electrode according to the first embodiment.

FIG. 9 is a relationship diagram between the fixed electrode and the movable electrode in a case where a detection electrode shape is set as an integrated rectangular shape according to the first embodiment.

FIG. 10A is a schematic diagram of the electric field shape formed between the fixed electrode and the movable electrode in a case where the detection electrode shape is set as the integrated rectangular shape according to the first embodiment.

FIG. 10B is a schematic diagram of the electric field shape formed between the fixed electrode and the movable electrode in a case where the detection electrode shape is set as the integrated rectangular shape according to the first embodiment.

FIG. 11 is a graphic representation illustrating the signal based on the electrostatic capacitance formed by the fixed electrode and the movable electrode and a signal in a case where the detection electrode shape is set as the integrated rectangular shape according to the first embodiment.

FIG. 12A is a relationship diagram between the fixed electrode and the movable electrode according to a second embodiment.

FIG. 12B is a relationship diagram between the fixed electrode and the movable electrode according to the second embodiment.

FIG. 13 is a graphic representation illustrating the signal based on the electrostatic capacitance formed by the fixed electrode and the movable electrode and the signal in a case where the detection electrode shape is set as the integrated rectangular shape according to the second embodiment.

FIG. 14 is a relationship diagram between the fixed electrode and the movable electrode according to a third embodiment.

FIG. 15 is a relationship diagram between the fixed electrode and the movable electrode according to a fourth embodiment.

FIG. 16 is a relationship diagram between the fixed electrode and the movable electrode according to a fifth embodiment.

FIG. 17 is a graphic representation illustrating the signal based on the electrostatic capacitance formed by the fixed electrode and the movable electrode and the signal in a case where the detection electrode shape is set as the integrated rectangular shape according to the fifth embodiment.

FIG. 18A is a configuration diagram of the interchangeable lens according to a sixth embodiment.

FIG. 18B is a configuration diagram of the interchangeable lens according to the sixth embodiment.

FIG. 18C is a configuration diagram of the interchangeable lens according to the sixth embodiment.

FIG. 18D is a configuration diagram of the interchangeable lens according to the sixth embodiment.

### DESCRIPTION OF EMBODIMENTS

Hereinafter, embodiments of the present invention will be described in detail with reference to the drawings.

Configuration of Imaging Apparatus

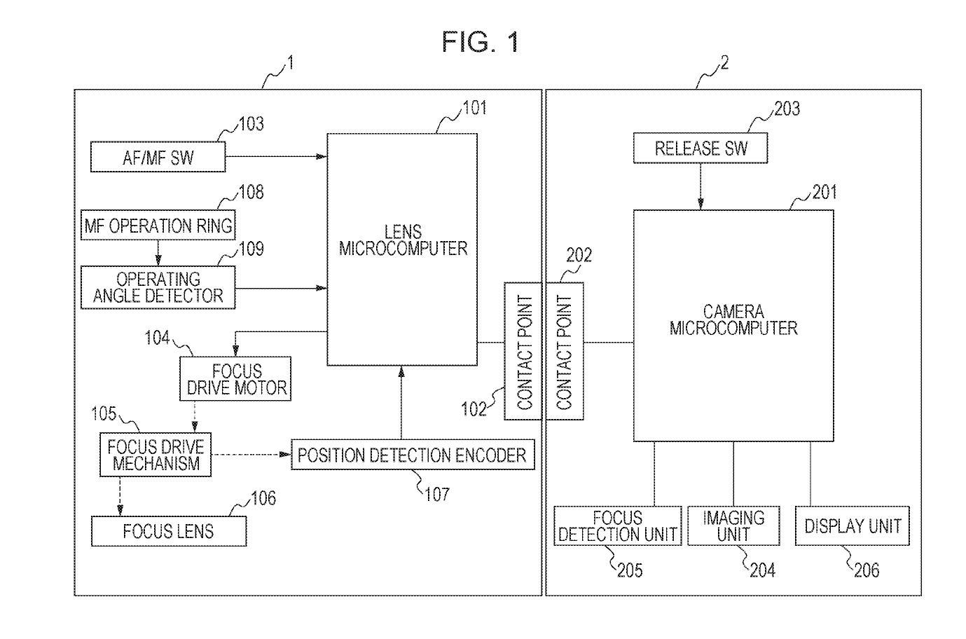

First, configurations of an imaging apparatus (imaging apparatus main body (single-lens reflex camera) to which a displacement detection apparatus can be mounted and a lens barrel (interchangeable lens)) that can be detachably attached to the imaging apparatus main body according to the respective embodiments of the present invention will be described with reference to FIG. 1. FIG. 1 is a block diagram of an imaging apparatus 100. In FIG. 1, a solid line that connects the respective blocks to each other indicates an electric connection, and a broken line indicates a mechanical connection.

The imaging apparatus 100 is provided with a camera 2 (imaging apparatus main body, camera main body) that holds an imaging element and an interchangeable lens 1 (lens barrel) that can be detachably attached to the camera 2. The interchangeable lens 1 is provided with an operating angle detector 109 (displacement detection apparatus) which will be described below and a focus lens 106 (lens unit) that drives on the basis of a detection result of a displacement by the operating angle detector 109. 201 denotes a camera microcomputer (control means), and 202 denotes a contact point. The camera microcomputer 201 controls the respective units of the camera 2 as will be described below and performs a communication with the interchangeable lens 1 via the contact point 202 at the time of the mounting of the interchangeable lens 1.

203 denotes a release switch of a two-stage stroke system. A signal output from the release switch 203 is input to the camera microcomputer 201. The camera microcomputer 201 performs a decision of an exposure amount by a photometric apparatus (not illustrated), an AF operation which will be described below, or the like and enters a capturing ready state in accordance with the signal input from the release switch 203 when a first-stage stroke switch (SW1) is ON. When an operation of the release switch 203 is detected until a second-stage stroke switch (SW2) turns ON, the camera microcomputer 201 also transmits a capturing start command to an imaging unit 204 to cause the imaging unit to perform an actual exposure operation. The imaging unit 204 includes an imaging element such as a CMOS sensor or a CCD sensor and performs photoelectric conversion of an optical image formed via the interchangeable lens 1 to output an image signal.

205 denotes a focus detection unit. When the SW1 of the release switch 203 is turned ON in a case where the camera 2 is set in the AF mode which will be described below, the focus detection unit 205 performs focus detection with respect to an object (subject) existing in a focus detection area in accordance with a focus detection start command transmitted from the camera microcomputer 201. As a result of the focus detection, the focus detection unit 205 decides movement information (movement direction and movement amount) in an optical axis direction of the focus lens 106 which is required for adjusting a focus on this object. 206 denotes a display unit, and a captured image obtained by the imaging unit 204 or the like is displayed.

101 denotes a lens microcomputer (control means) of the interchangeable lens 1. The lens microcomputer 101 performs control on the respective units of the interchangeable lens 1 as will be described below and also performs a communication with the camera 2 via a contact point 102. 103 denotes an AF/MF switch for switching auto focus and manual focus, which is used for a user to select a focus mode from among an AF (auto focus) mode and an MF (manual focus) mode.

In the AF mode, the camera microcomputer 201 transmits a focus detection result decided by the focus detection unit 205 to the lens microcomputer 101 in accordance with ON of the SW1 of the release switch 203. The lens microcomputer 101 activates a focus drive motor 104 that generates drive force by electric energy on the basis of this focus detection result. The drive force of the focus drive motor 104 is transmitted to a focus drive mechanism 105. Then, with the focus drive mechanism 105, the focus lens 106 is driven by the required movement amount in the optical axis direction. A stepping motor, an ultrasonic motor, or the like can be used as the focus drive motor 104. A so-called bar-sleeve supporting direct-activing mechanism, a so-called rotating cam mechanism based on a coordination of a cam ring including three cam grooves and three rectilinear grooves arranged in a fixed part, or the like can be applied as the focus drive mechanism 105.

107 denotes a position detection encoder (position detection means). The position detection encoder 107 is, for example, an absolute value encoder that outputs information corresponding to a position in the optical axis direction of the focus lens 106. A configuration can be applied as the position detection encoder 107 in which photo interrupters that decide a reference position are included, and an absolute position can be detected by an integrated value of incremental signals at a fine interval (for example, the number of drive pulses of the stepping motor or repetitive signals such as MR sensors).

In the AF mode, the lens microcomputer 101 drives and controls the focus drive motor 104 in accordance with the required movement amount of the focus lens 106 decided on the basis of the focus detection result of the focus detection unit 205. When the required movement amount of the focus lens 106 is equal to an actual movement amount corresponding to the detection result of the position detection encoder 107, the lens microcomputer 101 stops the focus drive motor 104 and transmits an effect that the focus control has ended to the camera microcomputer 201.

On the other hand, in the MF mode, the focus control can be performed when the user operates an MF operating ring 108 (movable member). 109 denotes an operating angle detector (displacement detection apparatus) that detects a rotating angle (displacement) of the MF operating ring 108. When the user rotates the MF operating ring 108 while a focus state of the subject is checked by the display unit 206, the lens microcomputer 101 reads an output signal of the operating angle detector 109 to drive the focus drive motor 104 and move the focus lens 106 in the optical axis direction. When the rotation of the MF operating ring 108 is finely detected by the operating angle detector 109, the user can perform the sensitive focus control, and operability in the MF mode is improved. A detail of the detection by the operating angle detector 109 will be described below.

Configuration of Lens Barrel

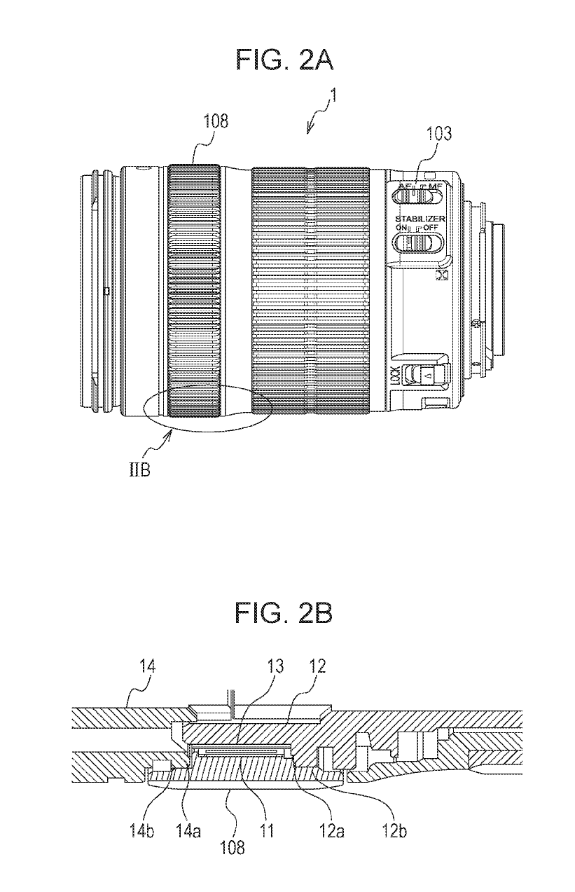

Next, a configuration of the interchangeable lens 1 will be described with reference to FIG. 2. FIG. 2 are configuration diagrams of the interchangeable lens 1. FIG. 2A is an external appearance view of the interchangeable lens 1. As illustrated in FIG. 2A, the AF/MF switch 103 is arranged on a side of a rear end part (on a right side in FIG. 2A) of the interchangeable lens 1. The MF operating ring 108 that is supported so as to be rotatable is arranged on a front end part (on a left side in FIG. 2A) of the interchangeable lens 1.

FIG. 2B is an expanded view of a range of an ellipse IIB in FIG. 2A and illustrates a main part cross-sectional view in a surrounding of the MF operating ring 108. 11 denotes a movable electrode (second electrode unit). The movable electrode 11 is a conductive electrode arranged to be integrated with an inner circumference wall that is coaxial to a rotation center axis of the MF operating ring 108. 12 denotes a guide tube (fixed member). 13 denotes a fixed electrode (first electrode unit) arranged to be integrated with the guide tube 12 while facing the movable electrode 11.

14 denotes a front frame which is integrated with the guide tube 12 in a part that is not illustrated in the drawing. The MF operating ring 108 is inserted with respect to surfaces 12a and 14a in a forth and back direction of an optical axis OA with a predetermined gap by the guide tube 12 and the front frame 14 and can rotate at a fixed position by inter-fitting support by cylindrical surfaces 12b and 14b. According to the present embodiment, with regard to the movable electrode 11, a metallic ring corresponding to a separate part as an conductive electrode is arranged on the inner circumference wall of the MF operating ring 108, and this metallic ring is constructed by being integrated with the MF operating ring 108.

The fixed electrode 13 is fixed to an outer circumference wall of the guide tube 12 by an adhesive tape or bonding while a copper foil pattern of a flexible substrate is set as an electrode. It should be noted however that the present embodiment is not limited to this, and an electrode pattern which will be described below may also be directly formed on the inner circumference wall of the MF operating ring 108 or the outer circumference wall of the guide tube 12 by using a technology such as plating, vapor deposition, or screen printing of a conductive material.

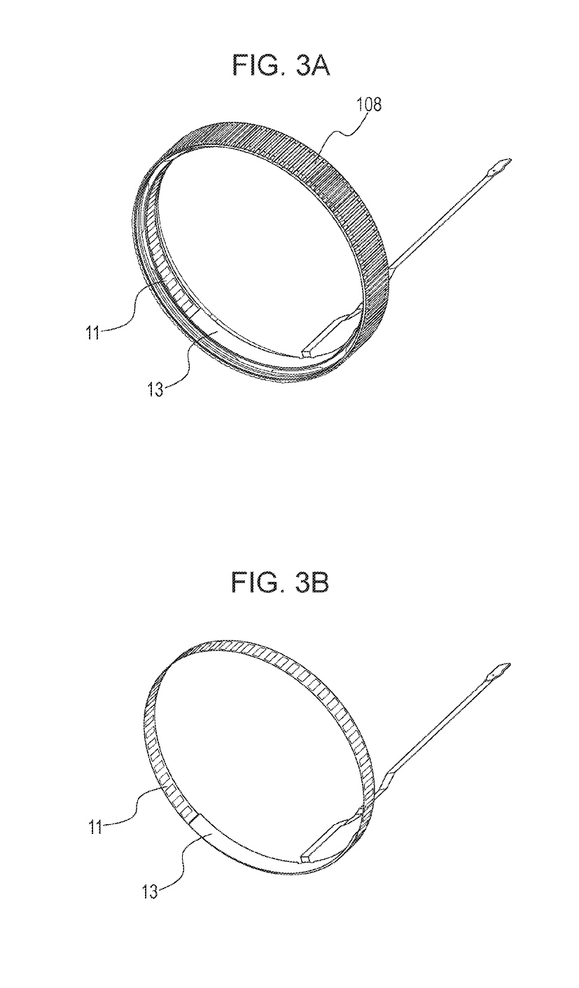

Next, configurations of the movable electrode 11 and the fixed electrode 13 will be described with reference to FIG. 3. FIG. 3 are exploded perspective views of the movable electrode 11 and the fixed electrode 13. FIG. 3A illustrates a relationship diagram among the MF operating ring 108, the movable electrode 11, and the fixed electrode 13. FIG. 3B illustrates a drawing of FIG. 3A from which the MF operating ring 108 is omitted. As illustrated in FIG. 3, the movable electrode 11 has a cylindrical shape in which repetitive patterns of the presence or absence of strip-shaped electrode units having conductivity are connected on an entire circumference in a direction around the optical axis. The fixed electrode 13 is a flexible substrate in a finite angle range which is arranged so as to face the movable electrode 11 and has a cylindrical shape coaxial to the movable electrode 11.

### First Embodiment

Configuration of Displacement Detection Apparatus

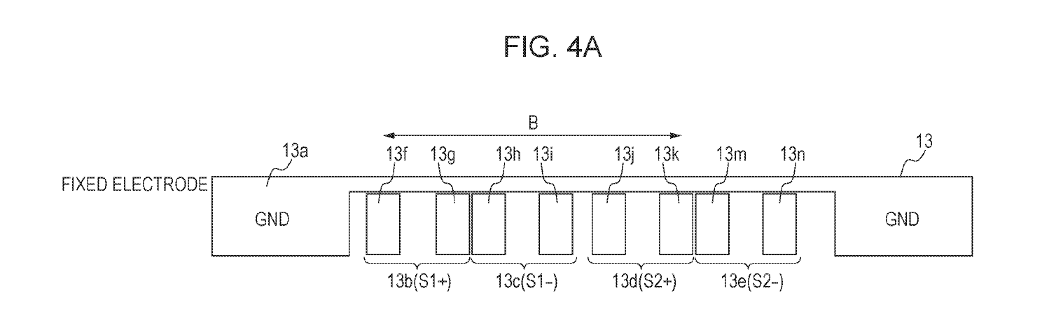

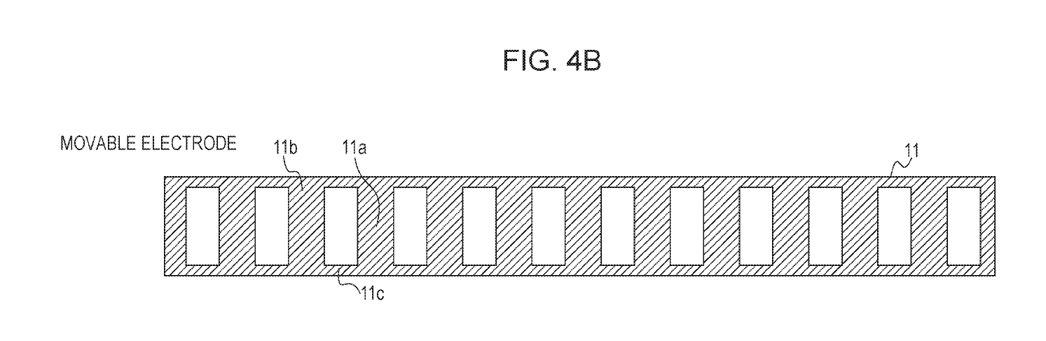

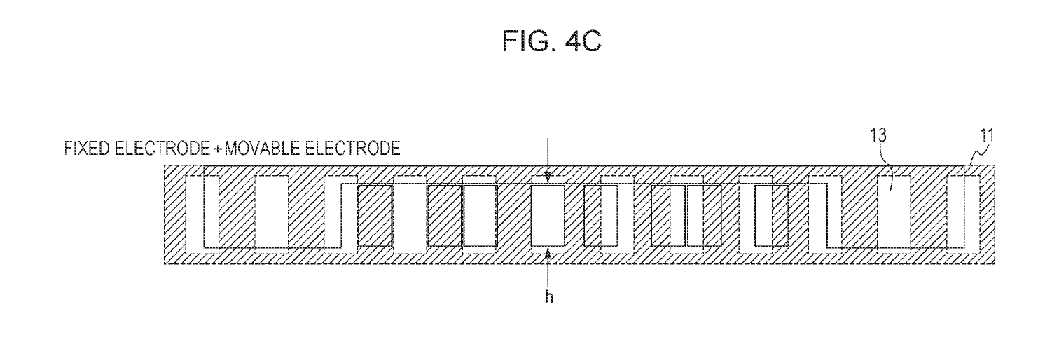

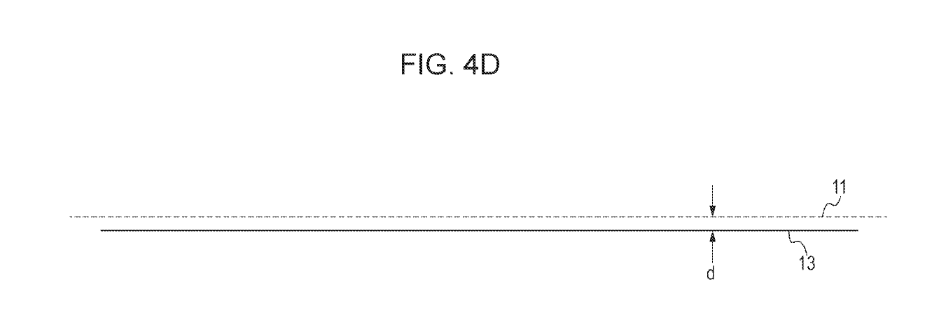

Next, according to a first embodiment of the present invention, a detection principle of the operating angle detector 109 that detects a rotating angle of the MF operating ring 108 will be described in detail with reference to FIG. 4. To facilitate explanation and understanding, the explanation will proceed in a planar state being expanded in a rotating direction corresponding to a detection direction.

FIG. 4 are detailed diagrams of the movable electrode 11 and the fixed electrode 13. FIG. 4A is a development diagram of the fixed electrode 13, FIG. 4B is a development diagram of the movable electrode 11, and FIG. 4C is a development diagram in which the fixed electrode 13 and the movable electrode 11 are overlapped with each other. A direction indicated by an arrow B in FIG. 4 is the detection direction (rotation direction).

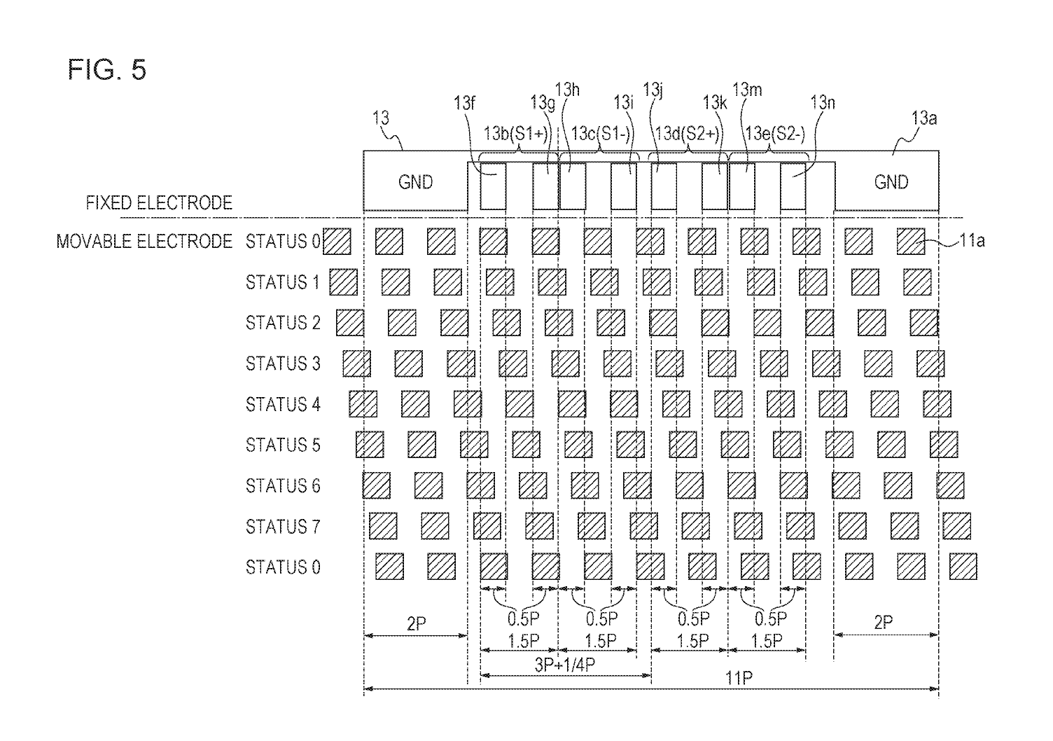

First, an electrode pattern of the fixed electrode 13 will be described with reference to FIG. 4A. It should be noted however that lengths of the respective electrodes in the detection direction will be described below with reference to FIG. 5. As illustrated in FIG. 4A, the fixed electrode 13 includes a reference electrode unit 13a (GND electrode) and detection electrode groups 13b, 13c, 13d, and 13e. The detection electrode groups 13b, 13c, 13d, and 13e are respectively an S1+ electrode, an S1− electrode, an S2+ electrode, and an S2− electrode and are also a first detection electrode group, a second detection electrode group, a third detection electrode group, and a fourth detection electrode group. The respective detection electrode groups 13b to 13e are constituted by a plurality of detection electrodes.

The detection electrode group 13b (S1+ electrode) is obtained by connecting a detection electrode 13f and a detection electrode 13g to each other by wiring which is not illustrated in the drawing, and the detection electrode group 13c (S1− electrode) is obtained by connecting a detection electrode 13h and a detection electrode 13i to each other by wiring which is not illustrated in the drawing. The detection electrode group 13d (S2+ electrode) is obtained by connecting a detection electrode 13j and a detection electrode 13k to each other by wiring which is not illustrated in the drawing, and the detection electrode group 13e (S2− electrode) is obtained by connecting a detection electrode 13m and a detection electrode 13n to each other by wiring which is not illustrated in the drawing. In FIG. 4A, boundaries of the respective electrodes are drawn to be adjacent to one another but insulated from one another while a minute gap is left in actuality.

FIG. 4B is an expanded view of the movable electrode 11 having the cylinder shape illustrated in FIG. 3. A shaded region in the movable electrode 11 is an electrode unit having conductivity. 11a denotes repetitive pattern electrodes having a role for changing a detection output, and 11b and 11c denote conductive electrodes for connecting each of the repetitive pattern electrodes 11a to be conductive. FIG. 4C illustrates the fixed electrode 13 and the movable electrode 11 overlapped with each other. In FIG. 4C, the movable electrode 11 is indicated by broken lines and oblique lines. In FIG. 4C, a length h indicates a region (length) where the repetitive pattern electrodes 11a and the detection electrode groups 13b to 13e are overlapped with each other in a direction orthogonal to a detection direction B and a region in which an electrostatic capacitance is formed as a capacitor. FIG. 4D illustrates the fixed electrode 13 and the movable electrode 11 as viewed from a direction orthogonal to both directions of the detection direction B and a direction of the length h. In FIG. 4D, a length d denotes a gap (interval) as the capacitor. An electrostatic capacitance C is in proportion to a dielectric constant of the area where the facing electrodes are mutually overlapped and the gap and is in inverse proportion to a gap d. That is, the electrostatic capacitance is represented as C=ε·S/d (C: an electrostatic capacitance, E: a dielectric constant, S: an area, d: a gap).

Relationship Between Fixed Electrode 13 and Movable Electrode 11

Next, a relationship between the fixed electrode 13 and the movable electrode 11 will be described with reference to FIG. 5. FIG. 5 is a relationship diagram between the fixed electrode 13 and the movable electrode 11. The respective electrode patterns of the fixed electrode 13 are illustrated in a top side of FIG. 5 similarly as in FIG. 4A. In a bottom side of FIG. 5, the repetitive pattern electrodes 11a of the movable electrode 11 are indicated by oblique lines. The repetitive pattern electrodes 11a form the capacitor by the region overlapped with each of the detection electrode groups 13b to 13e at the length h as illustrated in FIG. 4C. FIG. 5 illustrates eight feature statuses in an order of statuses 0 to 7 and to the status 0 in a process in which the movable electrode 11 is moved from a left side to a right side in the detection direction B. The movable electrode 11 and the fixed electrode 13 are overlapped with each other as illustrated in FIG. 4C to form the capacitor, and to facilitate understanding, descriptions will be made with reference to FIG. 5 in which these are arranged.

A repetitive pitch of the repetitive pattern electrodes 11a (period of the plurality of second electrodes) is set as P, and according to the present embodiment, the descriptions will be provided while the presence or absence (ratio) of the electrode in one pitch is set as half and half. In the following explanation, an area of one of the repetitive pattern electrodes 11a indicated by the oblique lines is set as “1” for convenience. The movement amount of the movable electrode 11 between the respective statuses is (⅛)P, the status 0 and the status 4 are in a state in which phases are mutually shifted (different) by 180 degrees with respect to the pitch P.

The reference electrode unit 13a (GND electrode) of the fixed electrode 13 is overlapped with the repetitive pattern electrodes 11a of the movable electrode 11 by a length of 4P in total mainly corresponding to a length of 2P respectively in the left and the right. In addition, part of the reference electrode unit 13a (GND electrode) is overlapped with the repetitive pattern electrodes 11a in a region at the length of 7P among the length of 11P in a region between the left and the light both at the length of 2P. That is, the reference electrode unit 13a has a length of an integral multiple of P in the detection direction B, which is the length 2P×2=4P in the left and the right or the entire length 11P according to the present embodiment. It should be noted that an effect of the region at the length of 7P where part of the reference electrode unit 13a is overlapped with the repetitive pattern electrodes 11a will be described below.

The length of the reference electrode unit 13a (GND electrode) is an integer multiple of the pitch P. For this reason, the area of the overlapped region of the reference electrode unit 13a (GND electrode) and the electrode unit (the repetitive pattern electrodes 11a) of the movable electrode 11 is regularly constant. Therefore, when the gap is constant, the electrostatic capacitance is also constant. In the detection electrode 13f and the detection electrode 13g, the electrode length is 0.5P, and a center-to-center distance of the electrodes is 1P. Similarly, in the detection electrode 13h and the detection electrode 13i too, the electrode length is 0.5P, and the center-to-center distance of the electrodes is 1P.

That is, both the detection electrode group 13b (S1+ electrode) and the detection electrode group 13c (S1− electrode) have the electrode length of 1.5P and mutually have a phase difference of 180 degrees. In other words, an S1+ detection electrode group 15 and an S1− detection electrode group 16 are arranged to be deviated by half a pitch (phase difference of 180 degrees, ½ pitch) of the repetitive period of the repetitive pattern electrodes 11a in the detection direction B.

That is, this is equivalent to a case where M is 1 in the length indicated by an expression of (M+0.5)×P (M is a natural number). The area of the overlapped region of the detection electrode group 13b (S1+ electrode) and the repetitive pattern electrodes 11a becomes “2” in the status 0 and “0” in the status 4, passes through the status 7, and returns to the area of “2” in the status 0. Subsequently, this change is repeated. When the gap is constant, the electrostatic capacitance changes along with this area change of the overlapped region.

In more detail, in the status 0 (maximum output state), a plurality of electrodes (the fourth and fifth electrodes from the bottom side on a sheet plane in the status 0 in FIG. 5) facing the region in which the detection electrode group 13b is arranged in the repetitive pattern electrodes 11a are set as a plurality of fourth counter electrodes. At this time, a center of each of the plurality of detection electrodes (13f and 13g) included in the detection electrode group 13b is substantially matched with a center of each of the plurality of fourth counter electrodes.

It should be noted that the substantial match mentioned herein can also be rephrased as follows. That is, a deviation between the center of each of the plurality of detection electrodes (13f and 13g) included in the detection electrode group 13b and the center of each of the plurality of fourth counter electrodes is set as D2, and a width of each of the plurality of detection electrodes included in the detection electrode group 13b is set as W2. At this time, in the maximum output state, a state in which 0≤D2/W2≤0.20 or 0≤D2/W2≤0.15 or 0≤D2/W2≤0.10 is satisfied may also be rephrased by the above-described substantially matched state.

In addition, in the status 4 (minimum output state), an electrode (the fourth electrode from the bottom side on the sheet place in the status 4 in FIG. 5) facing the region in which the detection electrode group 13b is arranged in the repetitive pattern electrodes 11a is set as a third counter electrode. At this time, a position of a center of each of the plurality of detection electrodes (13f and 13g) included in the detection electrode group 13b is different from a position of a center of the third counter electrode. In other words, in the maximum output state, each of the plurality of detection electrodes (13f and 13g) included in the detection electrode group 13b does not face the third counter electrode.

The lengths of the above-described respective detection electrode groups can also be rephrased as follows. That is, a period of the repetitive pattern electrodes 11a (the plurality of second electrodes) is set as P, M1 and M2 are set as natural numbers, and a direction in which the repetitive pattern electrodes 11a are aligned is set as a predetermined direction. At this time, the detection electrode group 13b has a length of (M1+0.5)×P in the predetermined direction, and the detection electrode group 13c has a length of (M2+0.5)×P in the predetermined direction. The detection electrode group 13b and the detection electrode group 13c may also mutually have the same length as described above.

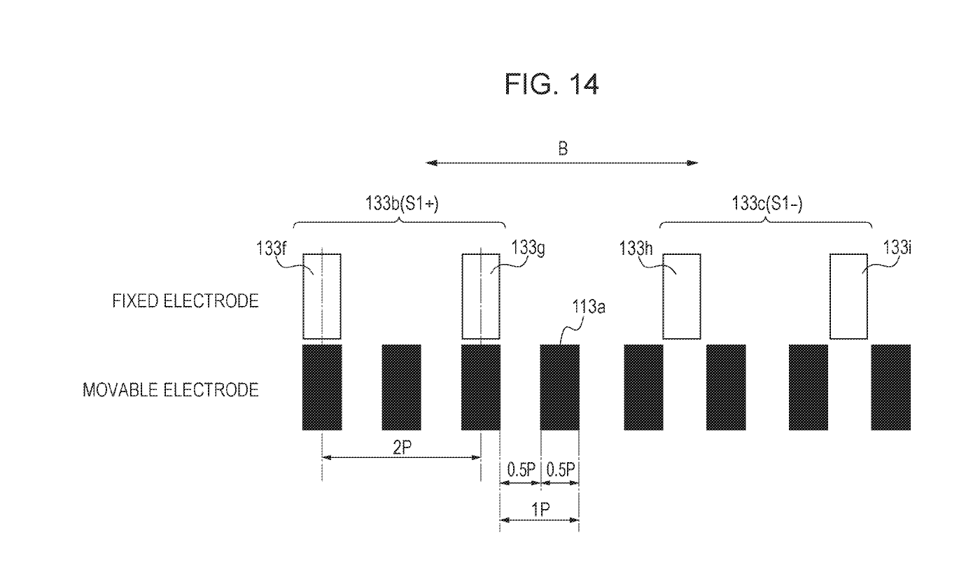

It should be noted that the length of the detection electrode group mentioned herein can also be considered as the length of the region in which the detection electrode group is arranged. The region in which the detection electrode group is arranged refers to a region including the detection electrodes arranged at the endmost among the detection electrodes included in the respective detection electrode groups (region indicated by brackets illustrated in FIG. 14), for example, as illustrated in FIG. 14 which will be described below.

In other words, the region in which the first detection electrode group is arranged refers to a region between two first detection electrodes mutually farther away from each other among a plurality of first detection electrodes in a direction in which the plurality of second electrodes are aligned. Similarly, the region in which the second detection electrode group is arranged refers to a region between two second detection electrodes mutually farther away from each other among a plurality of second detection electrodes in a direction in which the plurality of second electrodes are aligned.

On the other hand, the detection electrode group 13c (S1− electrode) has a phase difference of 180 degrees with respect to the detection electrode group 13b (S1+ electrode). For this reason, the area of the overlapped region of the detection electrode group 13c (S1− electrode) and the repetitive pattern electrodes 11a becomes “0” in the status 0 and becomes “2” in the status 4, and when the gap is constant, the electrostatic capacitance is also changed along with the overlap area.

In more detail, in the status 0 (maximum output state), an electrode facing the region in which the detection electrode group 13c is arranged among the repetitive pattern electrodes 11a (the sixth electrode from the bottom side on the paper plane in the status 0 in FIG. 5) is set as a first counter electrode. At this time, a position of the center of at least one (13h or 13i) of the plurality of detection electrodes included in the detection electrode group 13c is different from a position of a center of the first counter electrode. In other words, in the maximum output state, at least one (13h or 13i) of the plurality of detection electrodes included in the detection electrode group 13c does not face the first counter electrode.

In addition, in the status 4 (minimum output state), a plurality of electrodes (the fifth and sixth electrodes from the bottom side on the paper plane in the status 4 in FIG. 5) facing the region in which the detection electrode group 13c is arranged among the repetitive pattern electrodes 11a are set as a plurality of second counter electrodes. At this time, a center of each of the plurality of detection electrodes (13h and 13i) included in the detection electrode group 13c is substantially matched with a center of each of the plurality of second counter electrodes.

It should be noted that the substantial match mentioned herein can also be rephrased as follows. That is, a deviated amount between the center of each of the plurality of detection electrodes (13h and 13i) included in the detection electrode group 13c and the center of each of the plurality of second counter electrodes is set as D1, and a width of each of the plurality of detection electrodes included in the detection electrode group 13c is set as W1. At this time, in the minimum output state, a state in which 0≤D1/W1≤0.20 or 0≤D1/W1≤0.15 or 0≤D1/W1≤0.10 is satisfied is satisfied may also be rephrased by the above-described substantially matched state.

To summarize the above, in the maximum output state, the area of the region in which the detection electrode group 13b is arranged is overlapped with the movable electrode 11 is larger than the area of the region in which the detection electrode group 13c is arranged is overlapped with the movable electrode 11. Then, in the minimum output state, the area of the region in which the detection electrode group 13b is arranged is overlapped with the movable electrode 11 is smaller than the area of the region in which the detection electrode group 13c is arranged is overlapped with the movable electrode 11.

In this manner, with regard to the detection electrode group 13b (S1+ electrode) and the detection electrode group 13c (S1− electrode), the electrostatic capacitances mutually change in opposite manners. According to the present embodiment, the detection electrode group 13b (S1+ electrode) and the detection electrode group 13c (S1− electrode) are one set of a displacement detection electrode pair.

These detection electrode groups 13b and 13c are constituted by the plurality of detection electrodes, and a relationship in which the electrostatic capacitances mutually change in the opposite manners is equivalent to the following configuration. A time in the status 0 in which the detection electrode group 13b (S1+ electrode) has the maximum output will be considered. At this time, the area of the overlapped region of the region in which the detection electrode group 13b (S1+ electrode) is arranged and the repetitive pattern electrodes 11a of the movable electrode 11 is larger than the overlap area of the region in which the detection electrode group 13c (S1− electrode) is arranged and the repetitive pattern electrodes 11a. In addition, a position of a center of the overlap part of the region in which the detection electrode group 13c (S1-electrode) is arranged among the repetitive pattern electrodes 11a is different from positions of centers of the respective electrodes including the detection electrode 13h and the detection electrode 13i. An effect based on this will be described below.

The detection electrode 13j and the detection electrode 13k, and the detection electrode 13m and the detection electrode 13n also have the electrode length 0.5P, and the center-to-center distance of the electrodes is 1P. The detection electrode group 13d (S2+ electrode) and the detection electrode group 13e (S2− electrode) also respectively have the length indicated by (M+0.5)×P (M is a natural number) and are one set of a displacement detection electrode pair mutually having a phase difference of 180 degrees. In addition, with regard to the detection electrode group 13d (S2+ electrode) and the detection electrode group 13e (S2− electrode), M in the above-described expression is 1 similarly as in the detection electrode group 13b (S1+ electrode) and the detection electrode group 13c (S1− electrode).

As illustrated in FIG. 5, the two sets of displacement detection electrode pairs have a phase shift by 3P+(¼)P converted into the pitch P in the detection direction B, and two sets of electrostatic capacitances indicate changes mutually shifted by (¼)P. That is, the area of the overlapped region of the detection electrode group 13d (S2+ electrode) and the repetitive pattern electrodes 11a is “2” in the status 2 and “0” in the status 6. On the other hand, the detection electrode group 13e (S2− electrode) has a phase difference of 180 degrees with respect to the detection electrode group 13d (S2+ electrode). For this reason, the area of the overlapped region of the detection electrode group 13d (S2+ electrode) and the detection electrode group 13e (S2− electrode) in the same status have mutually opposite relationships.

Electric Field Shape Formed by Fixed Electrode 13 and Movable Electrode 11

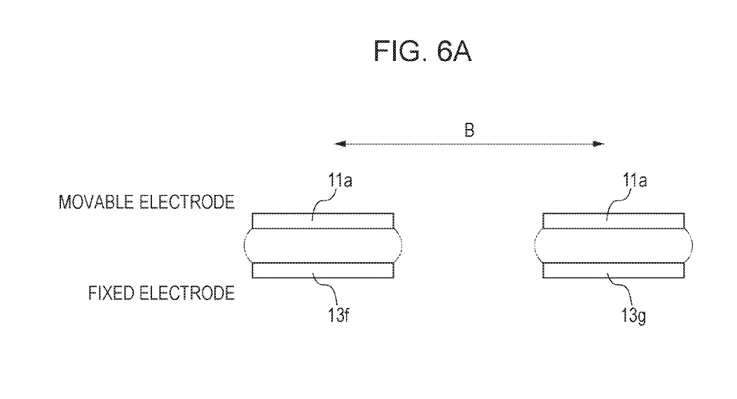

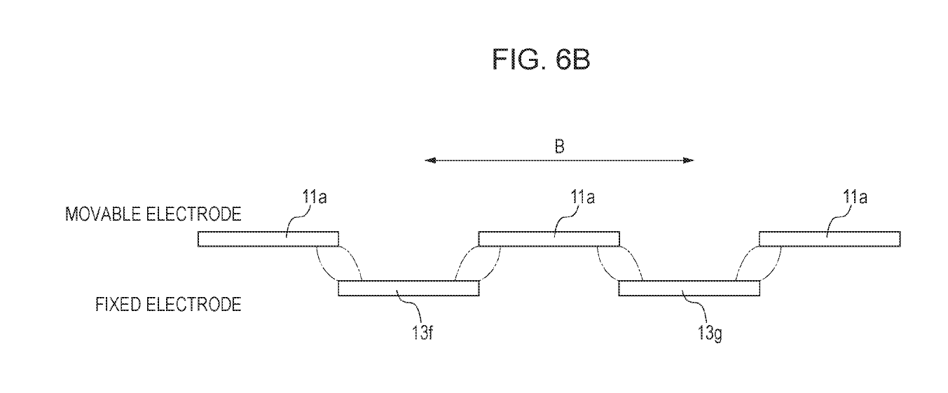

Next, an electric field shape formed by the fixed electrode 13 and the movable electrode 11 according to the present embodiment will be described with reference to FIG. 6. FIG. 6 illustrate the two electrodes 13f and 13g in the detection electrode group 13b (S1+ electrode) of the fixed electrode 13 and the repetitive pattern electrodes 11a of the movable electrode 11 as viewed from a direction orthogonal to both directions of the detection direction B and the length h. Originally, thicknesses of the fixed electrode 13 and the movable electrode 11 are sufficiently small with respect to the gap but are emphasized to be illustrated for the explanation. FIG. 6A illustrates a state in the status 0, and FIG. 6B illustrates a state in the status 4. FIG. 6A illustrates the maximum output state in which the area of the overlapped region the detection electrode group 13b (S1+ electrode) and the repetitive pattern electrodes 11a becomes the largest, and an electric field is formed in a part surrounded by the electrodes and dashed-dotted lines. FIG. 6B illustrates the minimum output state in which the area of the overlapped region of the detection electrode group 13b (S1+ electrode) and the repetitive pattern electrodes 11a becomes the lowest, and an electric field is formed in a part surrounded by the electrodes and dashed-dotted lines.

Equivalent Circuit of Capacitor and Signal Processing Unit

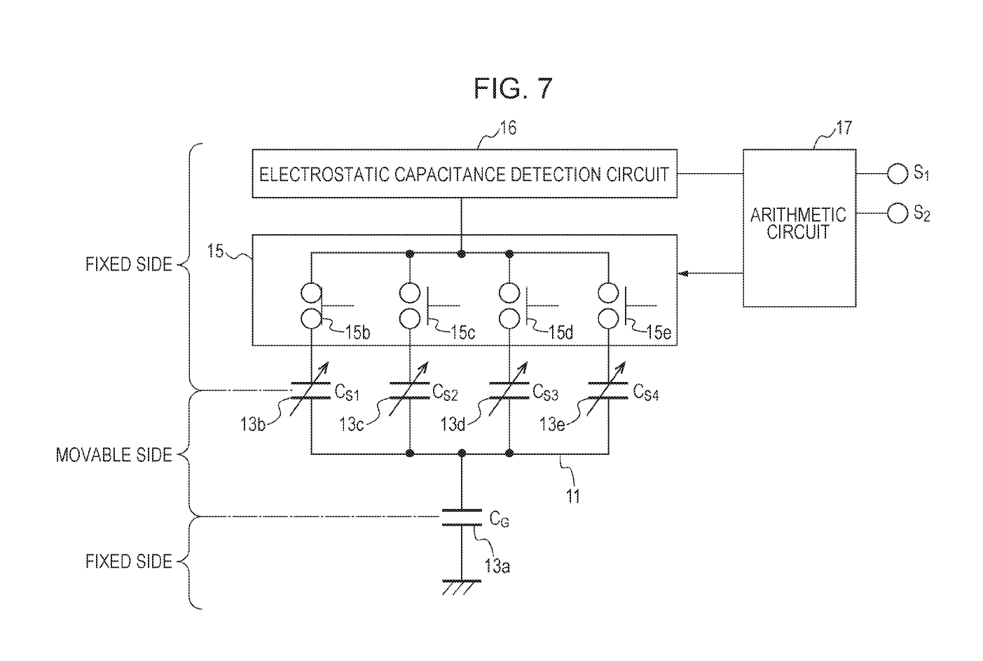

Next, an equivalent circuit of the capacitor formed by the fixed electrode 13 and the movable electrode 11 according to the present embodiment and a signal processing unit will be described with reference to FIG. 7. FIG. 7 is an equivalent circuit diagram of the fixed electrode 13 and the movable electrode 11 and a signal processing block diagram.

The fixed electrode 13 includes the reference electrode unit 13a (GND electrode), the detection electrode group 13b (S1+ electrode), the detection electrode group 13c (S1− electrode), the detection electrode group 13d (S2+ electrode), and the detection electrode group 13e (S2-electrode). As illustrated in FIG. 7, the respective electrodes constituting the fixed electrode 13 form the capacitor with respect to the movable electrode 11. Herein, the reference electrode unit 13a and the electrostatic capacitances of the capacitor formed by the detection electrode groups 13b to 13e are respectively set as C_{G}, C_{S1}, C_{S2}, C_{S3}, and C_{S4}. In a case where the gap d is constant, the electrostatic capacitances C_{S1}, C_{S2}, C_{S3}, and C_{S4} are variable capacitors that change by the movement of the movable electrode 11. On the other hand, the electrostatic capacitance C_{G} is a fixed-value capacitor that does not changed by the movement of the movable electrode 11.

15 denotes an analog switch array, 16 denotes an electrostatic capacitance detection circuit, and 17 denotes an arithmetic circuit (detection means or signal processing means). The analog switch array 15 includes analog switches 15b, 15c, 15d, and 15e. According to the present embodiment, the analog switches 15b to 15e are respectively connected to the detection electrode groups 13b to 13e in series. The arithmetic circuit 17 sets each of the analog switches 15b to 15e one by one in a short-circuited state in a time division manner. The electrostatic capacitance detection circuit 16 detects an electrostatic capacitance (combined electrostatic capacitance) obtained by combining the electrostatic capacitance C_{G} with each of the electrostatic capacitances C_{S1}, C_{S2}, C_{S3}, and C_{S4} connected to the electrostatic capacitance C_{G} in series. The arithmetic circuit 17 respectively outputs signals S₁ and S₂ on the basis of the detection result by the electrostatic capacitance detection circuit 16. Details of these signals will be described below.

Output Signal Based on Electrostatic Capacitance of Capacitor

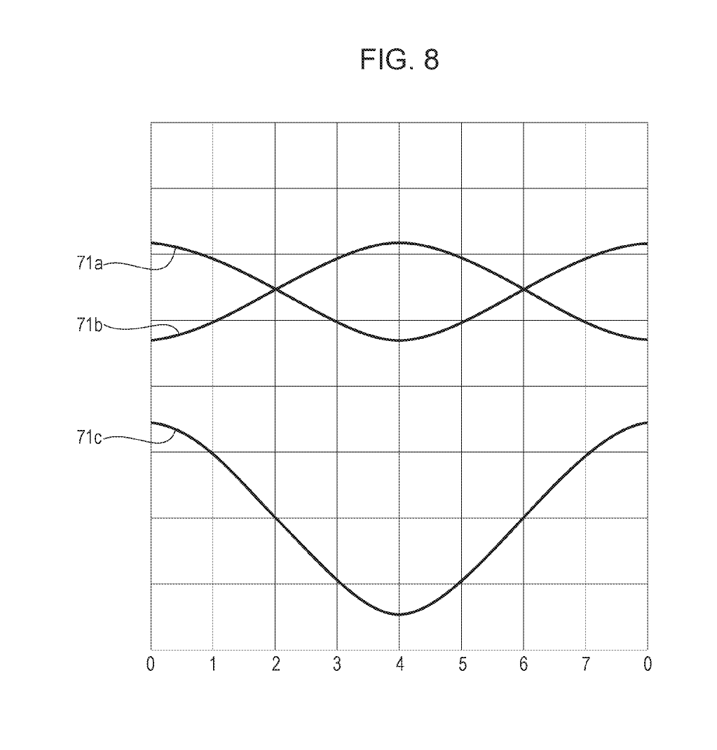

Next, an output signal based on the electrostatic capacitance of the capacitor formed by the fixed electrode 13 and the movable electrode 11 will be described with reference to FIG. 8. FIG. 8 is a graphic representation illustrating the simulation result of the output signal based on the electrostatic capacitance formed by the fixed electrode 13 and the movable electrode 11. FIG. 8 is an illustration related to the electrostatic capacitance of the capacitor corresponding, in particular, to the detection electrode group 13b (S1+ electrode) and the detection electrode group 13c (S1− electrode). In FIG. 8, the horizontal axis indicates the statuses 0 to 7 and 0 described with reference to FIG. 5, and the vertical axis indicates the electrostatic capacitance (combined capacitance, differential signal), respectively.

FIG. 8 is a graphic representation illustrating a combined capacitance C_{G_S1} of the electrostatic capacitances C_{G} and C_{S1} and a combined capacitance C_{G_S2} of the electrostatic capacitances C_{G} and C_{S2}. Inverse numbers of the combined capacitances C_{G_S1} and C_{G_S2} of the two capacitors connected in series are respectively equal to a sum of inverse numbers of the two capacitors. That is, 1/C_{G_S1}=1/C_{G}+1/C_{S1} and 1/C_{G_S2}=1/C_{G}+1/C_{S2} are established. This is equivalent to the combined capacitance indicated by a solid line 71a (C_{G_S1}) and a solid line 71b (C_{G_S2}) in FIG. 8.

In FIG. 8, the solid line 71a (C_{G_S1}) represents a combined capacitance of the detection electrode group 13b (S1+ electrode) and the reference electrode unit 13a (GND electrode). In addition, the solid line 71b (C_{G_S2}) represents a combined capacitance of the detection electrode group 13c (S1− electrode) and the reference electrode unit 13a (GND electrode). The detection electrode group 13c (S1− electrode) has a phase difference of 180 degrees with respect to the detection electrode group 13b (S1+ electrode). For this reason, the output value in the status 4 of the solid line 71b (C_{G_S2}) is equal to the output value in the status 0 of the solid line 71a (C_{G_S1}). A solid line 71c indicates a differential output (differential signal) of the displacement detection electrode pair. The solid line 71c indicates a differential signal S₁ of the solid line 71a (C_{G_S1}) and the solid line 71b (C_{G_S2}).

That is, the solid line 71c is equivalent to a signal obtained by subtracting the solid line 71b (C_{G_S2}) from the solid line 71a (C_{G_S1}). These differential operations are performed by the arithmetic circuit 17 illustrated in FIG. 7. Similarly also with regard to the detection electrode group 13d (S2+ electrode) and the detection electrode group 13e (S2− electrode), a differential signal S₂ of combined capacitances C_{G_S3} and C_{G_S4} of the reference electrode unit 13a (GND electrode) is calculated.

When the lens microcomputer 101 reads this differential signal from the arithmetic circuit 17 as needed, since the rotation of the MF operating ring 108 can be more finely detected, it is possible to further improve the operability in the MF mode. In addition, according to the present embodiment, the electrostatic capacitance information from the plurality of displacement detection electrode pairs for the displacement detection and the reference electrode pair is obtained by the differential operation. For this reason, the more stable displacement detection can be performed with respect to a floating capacitance and a parasitic capacitance generated between the respective electrodes or between neighboring substances.

Relationship Between Fixed Electrode 13 and Movable Electrode 11 in Comparative Example

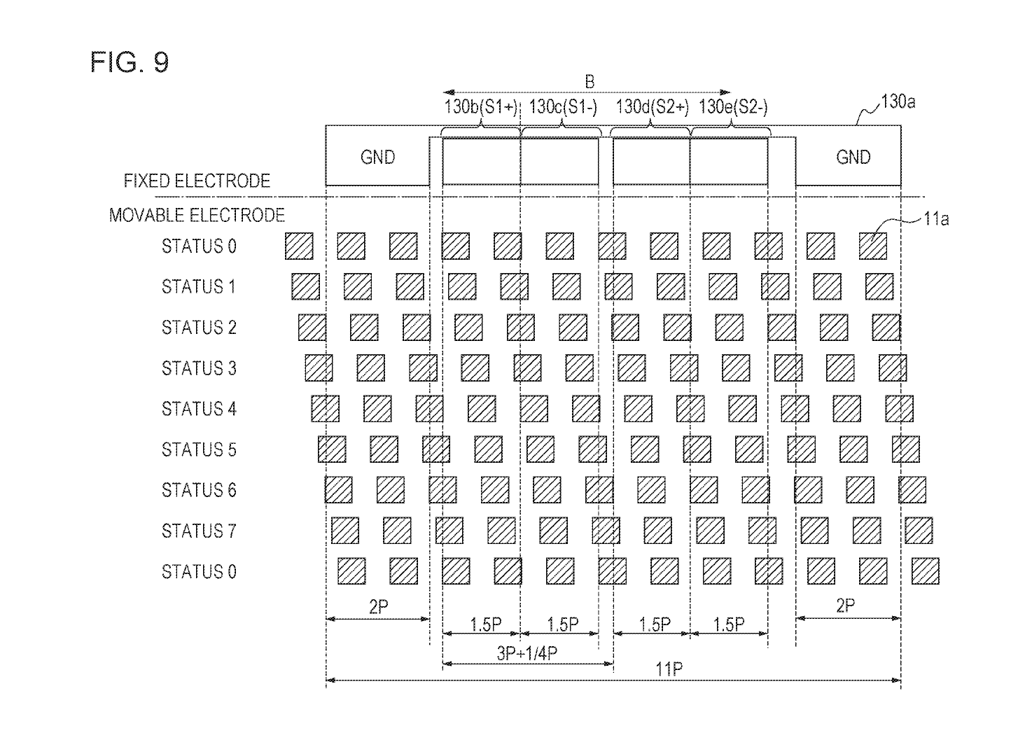

Next, a relationship between the fixed electrode 13 and the movable electrode 11 in a case where an integrated rectangular shape is arranged without arranging the plurality of detection electrodes in the respective detection electrode groups 13b to 13e according to a comparative example of the present invention will be described with reference to FIG. 9. Similarly as in FIG. 5, the respective electrode patterns of the fixed electrode 13 are indicated by oblique lines on the top side of FIG. 9, and the repetitive pattern electrodes 11a of the movable electrode 11 are indicated by oblique lines on the bottom side. FIG. 9 illustrates eight feature statuses in an order of the statuses 0 to 7 and to the status 0 in a process in which the movable electrode 11 is moved from the left side to the right side in the detection direction B.

A detection electrode group 130b (S1+ electrode) and a detection electrode group 130c (S1− electrode) have the electrode length of 1.5P and mutually have a phase difference of 180 degrees. The area of the overlapped region of the detection electrode group 130b (S1+ electrode) and the repetitive pattern electrodes 11a becomes “2” in the status 0 and “1” in the status 4, passes through the status 7, and returns to the area of “2” in the status 0. Subsequently, this change is repeated. In addition, the area of the overlapped region of the detection electrode group 130c (S1− electrode) and the repetitive pattern electrodes 11a becomes “1” in the status 0 and “2” in the status 4. A detection electrode group 130d (S2+ electrode) and a detection electrode group 130e (S2− electrode) are also one set of a displacement detection electrode pair that have the electrode length of 1.5P and mutually have a phase difference of 180 degrees.

Here, a case where the plurality of detection electrodes are arranged in the detection electrode group and a case where an integrated rectangular shape is arranged are compared with each other. The area in the maximum output state (status 0) in which the area of the overlapped region of the detection electrode group 130b (S1+ electrode) becomes the largest becomes “2” in both cases. On the other hand, the area in the minimum output state (status 4) in which the area of the overlapped region of the detection electrode group 130b (S1+ electrode) becomes the smallest becomes “0” in a case where the plurality of detection electrodes are arranged in the detection electrode group and becomes “1” in a case where the integrated rectangular shape is arranged.

Electric Field Shape in Comparative Example

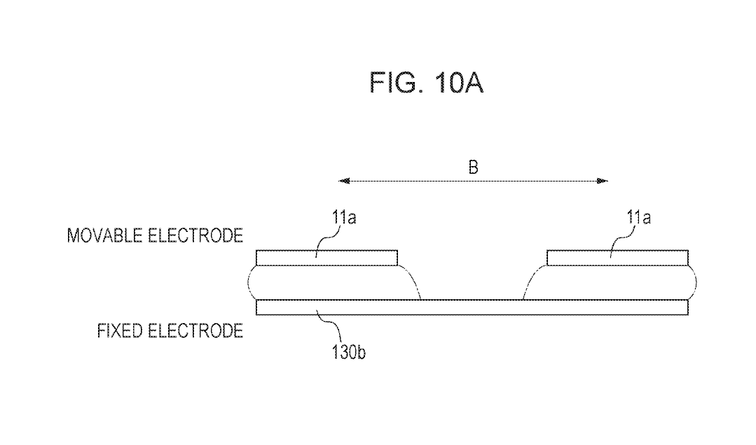

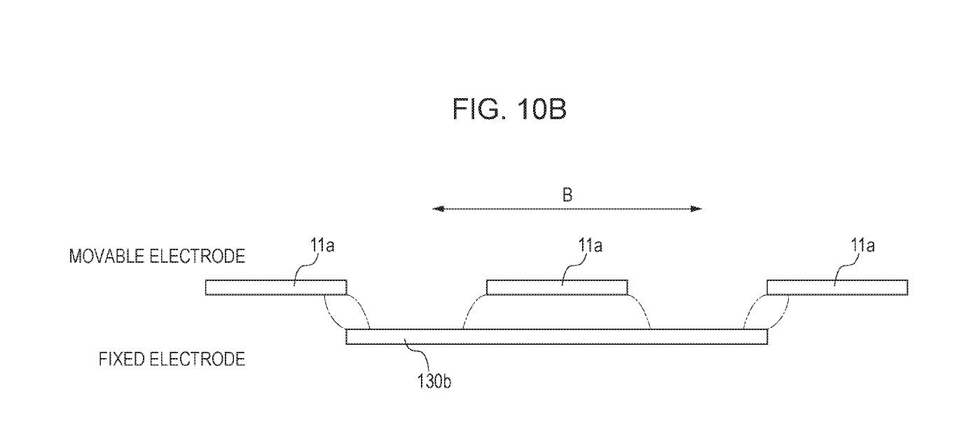

Next, the electric field shape formed by the fixed electrode 13 and the movable electrode 11 in a case where the integrated rectangular shape is arranged will be described with reference to FIG. 10 without arranging the plurality of detection electrodes in the respective detection electrode groups 13b to 13e. FIG. 10 illustrate the detection electrode group 130b (S1+ electrode) of the fixed electrode 13 and the repetitive pattern electrodes 11a of the movable electrode 11 as viewed from a direction orthogonal to the detection direction B and the length h. FIG. 10A illustrates a state in the status 0, and FIG. 10B illustrates a state in the status 4.

FIG. 10A illustrates the maximum output state in which the area of the overlapped region of the detection electrode group 130b (S1+ electrode) and the repetitive pattern electrodes 11a becomes the largest, and an electric field is formed in a part surrounded by the electrodes and dashed-dotted lines. As compared with FIG. 6A, the electric field is formed up to the part having integrated rectangular shape.

For this reason, the area of the overlapped region in the status 0 becomes “2” in both a case where the plurality of detection electrodes are arranged and a case where the integrated rectangular shape is arranged, but the output value becomes higher in a case where the integrated rectangular shape is arranged. FIG. 10B illustrates the minimum output state in which the area of the overlapped region of the detection electrode group 130b (S1+ electrode) and the repetitive pattern electrodes 11a becomes the lowest, and an electric field is formed in a part surrounded by the electrodes and dashed-dotted lines.

Output Signal According to Comparative Example

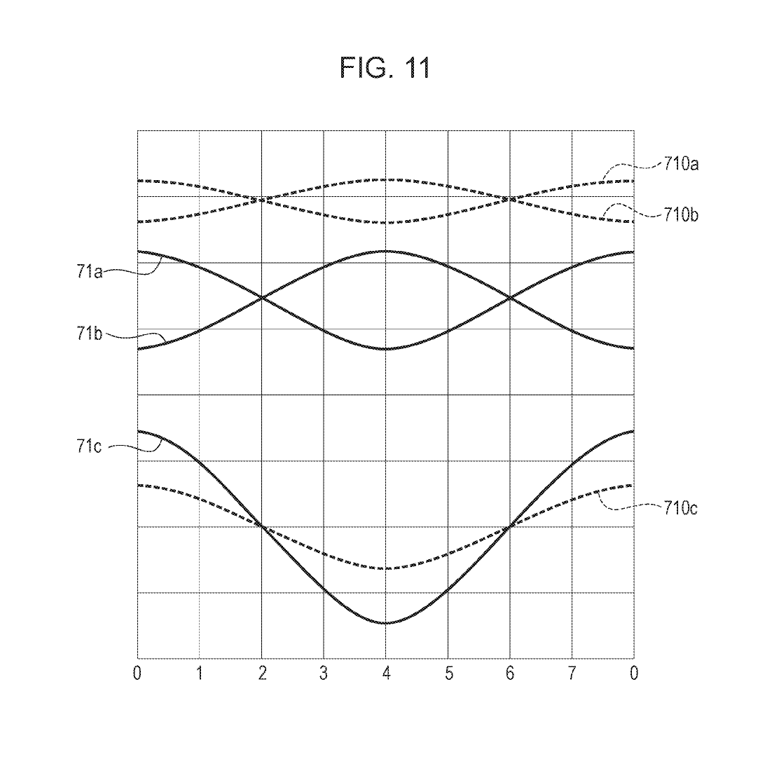

Next, an output signal in a case where the integrated rectangular shape is arranged without arranging the plurality of detection electrodes in the respective detection electrode groups 13b to 13e will be described with reference to FIG. 11. FIG. 11 is a graphic representation illustrating the simulation result of the output signal based on the electrostatic capacitance formed by the fixed electrode 13 and the movable electrode 11. The horizontal axis indicates the status, and the vertical axis indicates the output. A broken line 710a corresponds to the solid line 71a, a broken line 710b corresponds to the solid line 71b, a broken line 710c corresponds to the solid line 71c, the solid line indicates an output in a case where the plurality of detection electrodes are arranged in the detection electrode, and the broken line indicates an output in a case where a case where the integrated rectangular shape is arranged.

That is, the broken line 710a represents a combined capacitance of the detection electrode group 130b (S1+ electrode) and the reference electrode unit 13a (GND electrode). In addition, the broken line 710b represents a combined capacitance of the detection electrode group 130c (S1− electrode) and the reference electrode unit 13a (GND electrode). The broken line 710c indicates a differential output (differential signal) of the displacement detection electrode pair. The broken line 710c indicates a differential signal S₁ of the broken line 710a and the broken line 710b. That is, the broken line 710c is equivalent to a signal obtained by subtracting the broken line 710b from the broken line 710c.

When the broken line 710a and the solid line 71a are compared with each other, the output of the broken line 710a is higher. This is because, in a case where the integrated rectangular shape is arranged in the detection electrode, the electric field is formed up to a part where the electrode does not exist in a case where the plurality of detection electrodes are arranged. For this reason, the output in a case where the integrated rectangular shape is arranged becomes higher than a case where the plurality of detection electrodes are arranged. The same also applies to the broken line 710b and the solid line 71b.

On the other hand, the broken line 710c of the differential signal and the solid line 71c are compared with each other, the amplitude of the solid line 71c is higher. This is because the area of the overlapped region in a phase at which the area of the overlapped region of the repetitive pattern electrodes 11a and the detection electrode becomes the smallest is larger by 0.5P in a case where the integrated rectangle is arranged than a case where the plurality of detection electrodes are arranged. For this reason, the detection electrode group 130b (S1+ electrode) in which the integrated rectangular shape is arranged in the detection electrode has a small difference between the output maximum state and the output minimum state. According to this, the amplitude of the broken line 710c is lower than the amplitude of the solid line 71c.

Performance Difference Between Present Embodiment and Comparative Example

In this manner, according to the present embodiment, in the maximum output state, the region in which the detection electrode group 13c is arranged among the plurality of second electrodes is set as the first counter electrode. At this time, at least one of the second detection electrode among the plurality of second detection electrodes is arranged in a manner that a position of a center of the at least one second detection electrode is different from the position of the center of the first counter electrode. In other words, in the maximum output state, each of the plurality of second detection electrodes does not face the first counter electrode.

The first counter electrode mentioned herein refers to an electrode (the sixth electrode from the bottom side on the paper plane in the status 0 in FIG. 5) facing the region in which the detection electrode 13c is arranged among the repetitive pattern electrodes 11a in the status 0 (maximum output state) illustrated in FIG. 5. In the comparative example illustrated in FIG. 9, the center of the first counter electrode and a center of the detection electrode group 130c are matched with each other.

That is, as compared with the comparative example in which the integrated rectangular shape is arranged in the detection electrode, according to the present embodiment in which the plurality of detection electrodes are arranged, the overlap area of the detection electrode 13c and the repetitive pattern electrodes 11a can be reduced in the maximum output state. As a result, the differential signal output amplitude can be increased according to the present embodiment as compared with the comparative example.

When the differential signal output amplitude can be increased, S/N with respect to noise generated in the output is increased. For this reason, a resolution of the differential signal read by the lens microcomputer 101 from the arithmetic circuit 17. According to this, since the rotation of the MF operating ring 108 can be more finely detected, it is possible to further improve the operability in the MF mode.

In the present embodiment, the presence or absence (ratio) of the electrode in 1 pitch of the repetitive pattern electrodes 11a is set as half and half, but the effect of the present embodiment is not lost even in a case where a ratio other than this is set. In addition, the length of the detection electrode is set as 0.5P, but the effect of the present embodiment is not lost even in a case where a length other than this is set.

Effect Attained by Present Embodiment

In this manner, the operating angle detector 109 according to the present embodiment is provided with the fixed electrode 13 (first electrode unit) including the plurality of detection electrode groups and the movable electrode 11 (second electrode unit) having the predetermined periodic pattern and including the plurality of second electrodes that is movable relatively with respect to the first electrode unit. Furthermore, the operating angle detector 109 is provided with the arithmetic circuit 17 (detection means) that detects the displacement on the basis of the electrostatic capacitance between the fixed electrode 13 and the movable electrode 11.

Then, the plurality of above-described detection electrode groups include the detection electrode group 13b (the first detection electrode group) including the plurality of first detection electrodes. Furthermore, the detection electrode group 13c (the second detection electrode group) having a phase difference of 180 degrees with respect to the detection electrode group 13b with regard to the predetermined periodic pattern described above and also including the plurality of second detection electrodes is included.

Herein, a state in which the area where the detection electrode group 13b is overlapped with the detection electrode group 13c becomes the largest is set as the maximum output state. At this time, in the maximum output state, the area where the region in which the detection electrode group 13b is arranged is overlapped with the movable electrode 11 is larger than the area where the region in which the detection electrode group 13c is arranged is overlapped with the movable electrode 11.

Then, in the maximum output state, the region in which the detection electrode group 13c is arranged among the plurality of second electrodes is set as the first counter electrode. At this time, at least one of the second detection electrode among the plurality of second detection electrodes is arranged in a manner that a position of a center of the at least one second detection electrode is different from a position of a center of the first counter electrode.

With the above-described configuration, since the operating angle detector 109 according to the present embodiment is not required to emit light like photo interrupters, it is possible to reduce power consumption as compared with the related-art displacement detection apparatus using the photo interrupters.

Other Effects

In addition, the output signal changes in a light shielding section and a slit section in the photo interrupters, and outputs of the photo interrupters hardly change in the movement within a width of the light shielding section or a width of a slit. For this reason, since a rotation of a rotating operation unit cannot be detected in a range where both outputs of the pair of photo interrupters do not change, it is difficult to further increase the resolution of the rotation detection.

In contrast to this, the amplitude of the differential signal output can be increased in the operating angle detector 109 according to the present embodiment as described above. When the output amplitude of the differential signal is increased, S/N with respect to the noise generated in the output is increased. For this reason, the resolution of the differential signal read by the lens microcomputer 101 from the arithmetic circuit 17 is increased. As a result, it is possible to increase the resolution as compared with the related-art displacement detection apparatus using the photo interrupters. It should be noted that an effect similar to the present embodiment can also be attained according to subsequent respective embodiments of the present invention.

### Second Embodiment

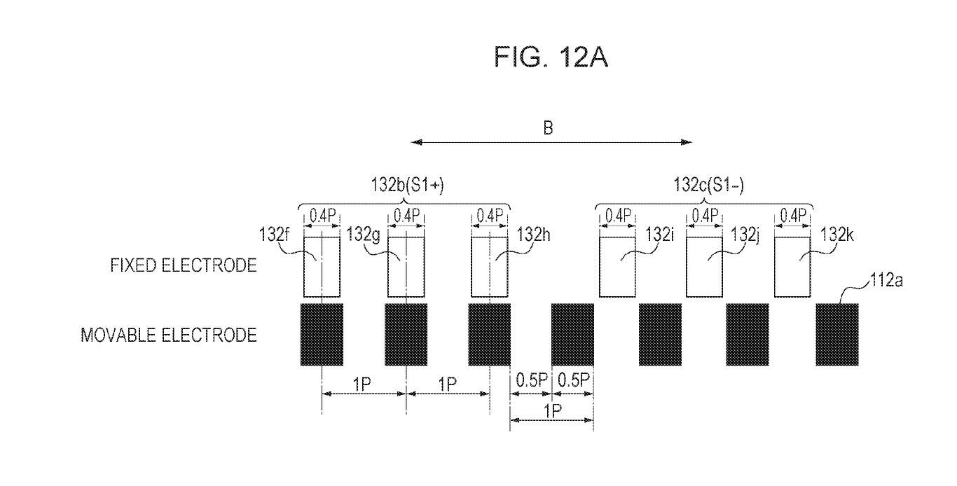

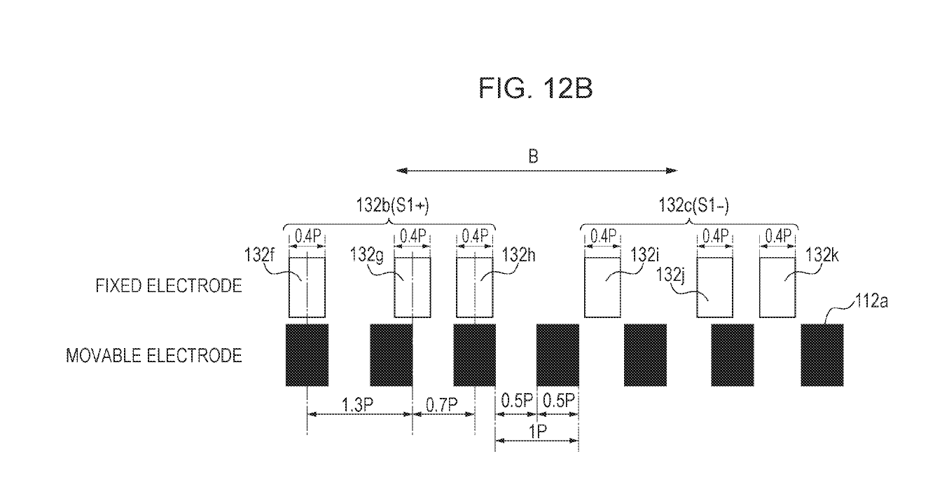

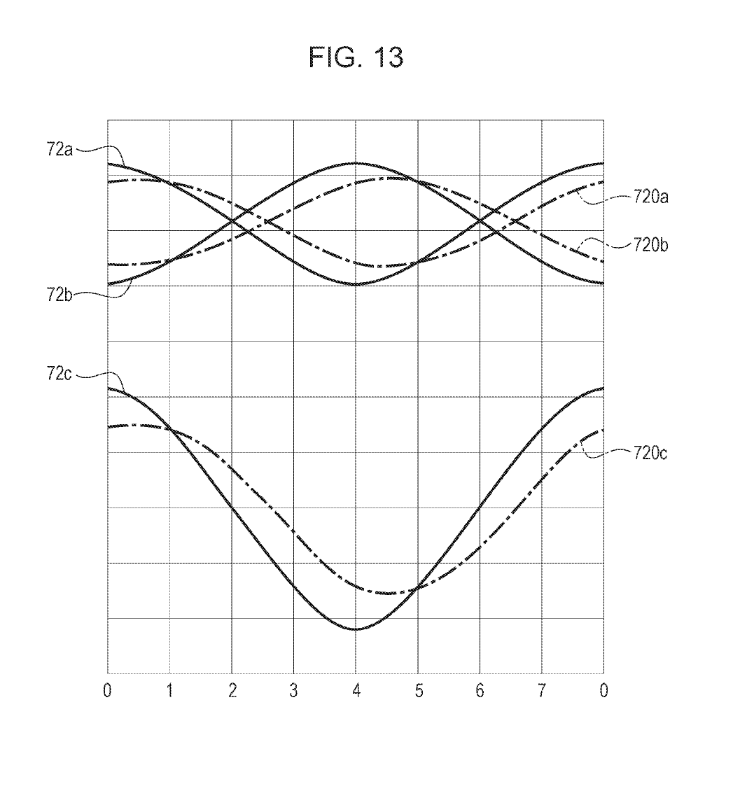

Next, a second embodiment of the present invention will be described with reference to FIG. 12 and FIG. 13. According to the present embodiment, the length and the position of the detection electrode are different from the first embodiment.

FIG. 12 illustrate a detection electrode group 132b (S1+ electrode) of the fixed electrode, a detection electrode group 132c (S1− electrode) having a phase difference of 180 degrees and repetitive pattern electrodes 112a of the movable electrode. The detection electrode group 132b (S1+ electrode) is equivalent to the maximum output state in which the area of the overlapped region with the repetitive pattern electrodes 112a becomes the largest, and the detection electrode group 132c (S1− electrode) is equivalent to the minimum output state in which the area of the overlapped region with the repetitive pattern electrodes 112a becomes the smallest.

The detection electrode group 132b (S1+ electrode) and the detection electrode group 132c (S1− electrode) are constituted by a plurality of detection electrodes 132f to 132k. With respect to the length of 0.5P of the repetitive pattern electrodes 112a of the movable electrode, a length of the respective electrodes the plurality of detection electrodes 132f to 132k is 0.4P. In addition, a center-to-center distance between the respective detection electrodes in FIG. 12A (dashed-dotted line in FIG. 12A) is 1P. That is, this is equivalent to a case where N is 1 in the length represented by an expression of N×P (N is a natural number).

In other words, a period of the repetitive pattern electrodes 112a is set as P, N1 and N2 are set as natural numbers, and a center-to-center distance between each of the plurality of second detection electrodes included in the detection electrode group 132c as the second detection electrode group is set as N1×P. Similarly, a center-to-center distance between each of the plurality of first detection electrodes included in the detection electrode group 132b as the first detection electrode group is set as a center-to-center distance between N2×P.

Even in a case where the length of the repetitive pattern electrodes 112a and the lengths of the plurality of detection electrodes 132f to 132k are not matched with one another as in the present embodiment, the output amplitude of the differential signal is increased as compared with a case where the integrated rectangular shape is arranged in the detection electrode similarly as in the first embodiment. This is because the area of the overlapped region is small in the minimum output state in which the area of the overlapped region the detection electrode unit and the repetitive pattern electrodes 112a becomes the smallest similarly as in the first embodiment.

Next, a case where center-to-center distances between the plurality of detection electrodes 132f to 132k is not close to N×P (N is a natural number) as in FIG. 12B will be described. The center-to-center distance between the electrode 132f and the electrode 132g is 1.25P, and the center-to-center distance between the electrode 132g and the electrode 132h is 0.75P. In this case, at the time of a phase in which centers of the electrode 132f, the electrode 132h, and the repetitive pattern electrodes 112a are matched with one another (phase in which the area of the overlapped region is the largest), centers of the electrode 132g, the electrode 132h, and the repetitive pattern electrodes 112a are not matched with one another.

That is, a phase when outputs of the electrode 132f and the electrode 132h become the maximum and a phase when an output of the electrode 132g becomes the maximum are shifted from each other. Similarly, also with regard to phases when outputs become the minimum, a phase in which a certain electrode has the minimum output and a phase in which the other electrode has the minimum output are shifted from each other.

Next, an output signal when the arrangement is set as described in FIG. 12A and FIG. 12B will be described with reference to FIG. 13. FIG. 13 is a graphic representation illustrating the output signal based on the electrostatic capacitance formed by the fixed electrode 13 and the movable electrode 11. The horizontal axis indicates status, and the vertical axis indicates the output. A solid line 72a and a dashed-dotted line 720a indicate a combined capacitance of the detection electrode group 132b (S1+ electrode) and the reference electrode unit 13a (GND). A solid line 72b and a dashed-dotted line 720b indicate a combined capacitance of the detection electrode group 132c (S1− electrode) and the reference electrode unit 13a (GND). A solid line 72c and the dashed-dotted line 720c indicate a differential output (differential signal) of the displacement detection electrode pair. The solid line 72c indicates a differential signal of the solid line 72a and the solid line 72b, and the dashed-dotted line 720c indicates a differential signal of the dashed-dotted line 720a and the dashed-dotted line 720b.

As described above, since phases in which the outputs of the electrode 132g, the electrode 132f, and the electrode 132h become the maximum are shifted from one another, the output value indicated by the dashed-dotted line has a shape like overlapped mountains with peaks shifted from each other. For this reason, an output shape becomes an asymmetric irregular shape. When the output shape becomes irregular as described above, it becomes difficult to stably operate the rotation of the MF operating ring 108. In addition, an output amplification of the dashed-dotted line 720c is lower than an output amplification of the solid line 72c. This is also because the phases in which the outputs of the electrode 132g, the electrode 132f, and the electrode 132h become the maximum are shifted from one another.

For this reason, as in FIG. 12A, the center-to-center distances between the respective electrodes of the plurality of detection electrodes 132f to 132k preferably become close to N×P (N is a natural number). According to this, even when the movable electrode is being moved in the detection direction B, the areas of the overlapped regions of the electrode 132f, the electrode 132g, and the electrode 132h and the repetitive pattern electrodes 112a become close to one another. That is, it is possible to avoid a situation where the output shape becomes irregular and the output amplitude becomes low. For this reason, it is possible to attain an effect that the rotation of the MF operating ring 108 can be stably moved.

### Third Embodiment

Next, a third embodiment of the present invention will be described with reference to FIG. 14. According to the present embodiment, the shape and the position of the detection electrode are different from the first and second embodiments.

FIG. 14 illustrates a detection electrode group 133b (S1+ electrode) of the fixed electrode, a detection electrode group 133c (S1− electrode) having a phase difference of 180 degree, and repetitive pattern electrodes 113a of the movable electrode. The detection electrode group 133b (S1+ electrode) and the detection electrode group 133c (S1− electrode) are respectively constituted by a plurality of electrodes 133f, 133g, 133h, and 133i. A center-to-center distance between the electrode 133f and the electrode 133g is 2P. That is, this is equivalent to a case where N is 2 in the length represented by the expression of N×P (N is a natural number). In this manner, even when the center-to-center distance between the electrode 133f and the electrode 133g is longer than or equal to 2P, the area of the overlapped region of the repetitive pattern electrodes 113a and the detection electrode group 133b (S1+ electrode) for each status is similar to the case of the first embodiment, and a similar output can be obtained.

### Fourth Embodiment

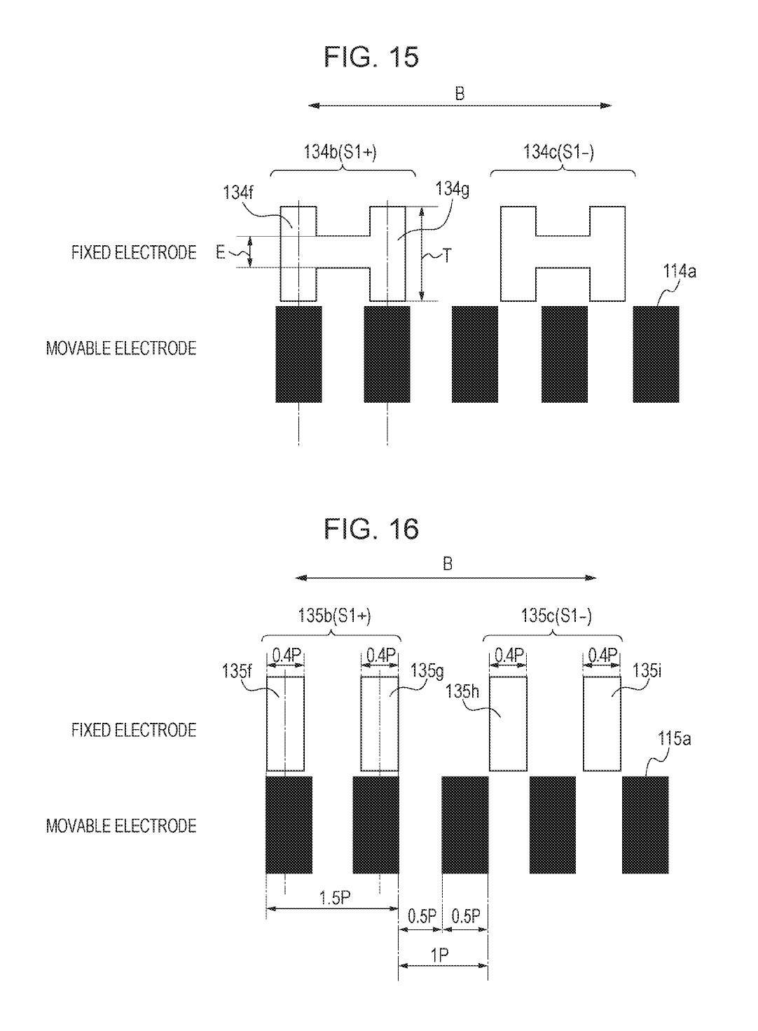

Next, a fourth embodiment of the present invention will be described with reference to FIG. 15. According to the present embodiment, the shape of the detection electrode is different from the first, second, and third embodiments.

FIG. 15 illustrates a configuration of a detection electrode group 134b and a detection electrode group 134c in a form where a plurality of electrodes 134f and 134g are connected in a range overlapped with a repetitive pattern electrode 114a (range of the length h in FIG. 4C). In other words, the detection electrode group 134b serving as the first detection electrode group is provided with a first connection electrode that connects the plurality of first detection electrodes (134f and 134g) and the plurality of first detection electrodes to one another. Similarly, the detection electrode group 134c serving as the third detection electrode group is provided with a second connection electrode that connects the plurality of second detection electrodes and the plurality of second detection electrodes to one another. Then, in the maximum output state, a position of a center of at least one of the second detection electrodes is different from the position of the center of the first counter electrode (movable electrode facing the second connection electrode in FIG. 15).

When a ratio of a height E of a connection section with respect to a height T of the plurality of electrodes 134f and 134g is half, the differential output (differential signal) of the displacement detection electrode pair is in the vicinity of the middle of the solid line 71c and the broken line 710c of FIG. 11. In this case too, since the output amplitude improvement effect of the differential signal is attained as compared with a case where the integrated rectangular shape is arranged in the detection electrode, the rotation of the MF operating ring 108 can be more finely detected, and it is possible to further improve the operability in the MF mode.

In addition, according to the first to third embodiments, wiring (not illustrated) that connects the two electrodes to each other is required outside the range (range of the length h in FIG. 4C) overlapped with the repetitive pattern electrode 114a. In contrast to the above, according to the present embodiment, wiring that connects the plurality of electrodes 134f and 134g to each other is not required to be separately prepared outside the range (range of the length h in FIG. 4C) overlapped with the repetitive pattern electrode 114a, it is possible to decrease the width (vertical direction on the paper plane) including the wiring of the fixed electrode.

### Fifth Embodiment

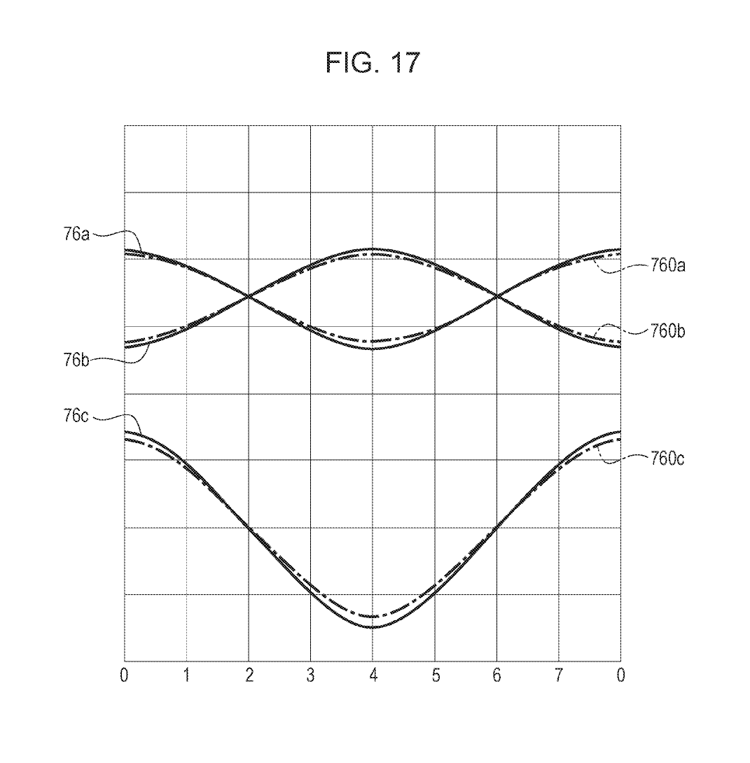

Next, a fifth embodiment of the present invention will be described with reference to FIG. 16 and FIG. 17. According to the present embodiment, the shape and the position of the detection electrode are different from the first to fourth embodiments.

FIG. 16 illustrates a detection electrode group 135b (S1+ electrode) of the fixed electrode, a detection electrode group 135c (S1− electrode) having a phase difference of 180 degrees, and a repetition pattern electrode 115a of the movable electrode. The detection electrode group 135b (S1+ electrode) and the detection electrode group 135c (S1− electrode) are respectively constituted by a plurality of electrodes 135f, 135g, 135h, and 135i. The electrode 135f and the electrode 135g are formed such that a length of the respective electrodes is set as 0.4P, and a distance from an edge to an edge of the two electrodes becomes 1.5P. When the formation is performed as described above, a distance between electrode centers of the electrode 135f and the electrode 135g does not become N×P.

FIG. 17 is a graphic representation illustrating the output signal based on the electrostatic capacitance formed by the fixed electrode 13 and the movable electrode 11. The horizontal axis indicates status, and the vertical axis indicates the output. Solid lines 76a, 76b, and 76c illustrate output values at the time of a configuration in which a center-to-center distance between the electrodes of the electrode 135f and the electrode 135g becomes 1P, and dashed-dotted lines 760a, 760b, and 760c illustrate output values at the time of a configuration in which the electrode 135f and the electrode 135g have an arrangement according to the present embodiment. The solid line 76a and the dashed-dotted line 760a indicate a combined capacitance of the detection electrode group 135b (S1+ electrode) and the reference electrode unit 13a (GND).

The solid line 76b and the dashed-dotted line 760b indicate a combined capacitance of the detection electrode group 135c (S1− electrode) and the reference electrode unit 13a (GND). The solid line 76c and the dashed-dotted line 760c indicate a differential output (differential signal) of the displacement detection electrode pair. The solid line 76c indicates a differential signal of the solid line 76a and the solid line 76b, and the dashed-dotted line 760c indicates a differential signal of the dashed-dotted line 760a and the dashed-dotted line 760b.

According to the present embodiment, since the distance between the electrode centers of the electrode 135f and the electrode 135g does not become N×P, as described according to the second embodiment, the phases in which output peaks of the respective electrodes are realized are shifted from each other. For this reason, a shape like overlapped mountains with peaks shifted from each other is obtained, the output amplitude becomes low. However, in the above-described case too, as compared with a case where the integrated rectangular shape is arranged in the detection electrode group 135b (S1+ electrode), the effect that the output amplitude of the differential signal is high is lost.

### Sixth Embodiment

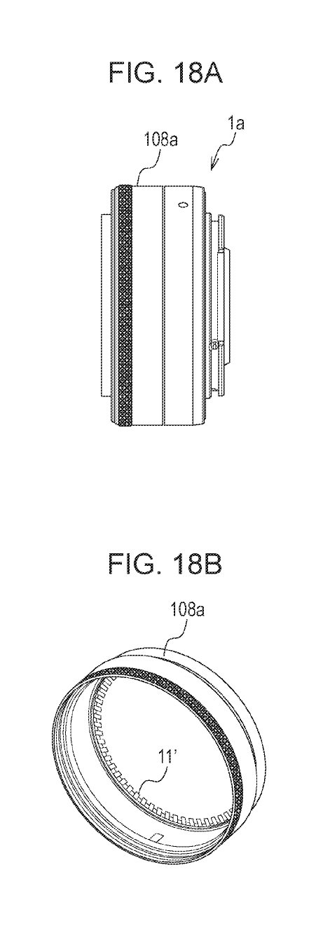

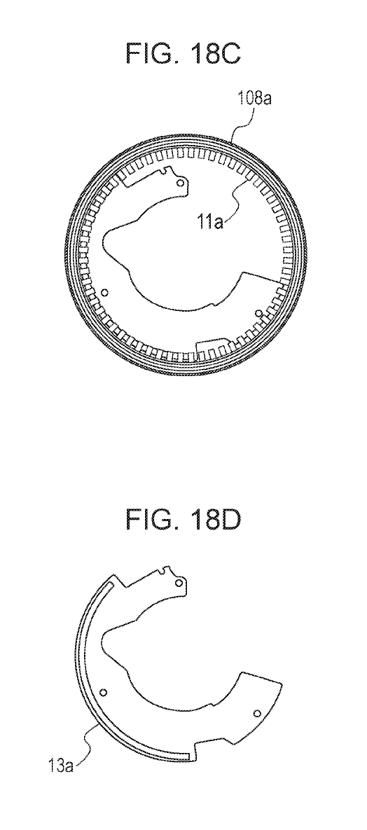

Next, a sixth embodiment of the present invention will be described with reference to FIG. 18. FIG. 18 are configuration diagrams of the interchangeable lens 1a according to the present embodiment.

FIG. 18A is an external view of an interchangeable lens 1a. 108a denotes an MF operating ring (movable member). FIG. 18B is a perspective view of the MF operating ring 108a. 111 denotes a movable electrode. The movable electrode 11 according to the first embodiment is an electrode having a tubular shape, but the movable electrode 111 according to the present embodiment is a disc-like electrode. As illustrated in FIG. 18B, the movable electrode 111 is constituted in a manner that an electrode that is extended in a radial direction includes repetitive patterns of the presence or absence of fan-like electrodes in a circumferential direction, and so-called comb teeth parts in the movable electrode 111 are connected to one another on an outer side, and mutual fan-like electrodes are in continuity.

FIG. 18C illustrates the MF operating ring 108a with which the movable electrode 111 is integrated and a fixed electrode 113 including the reference electrode and the detection electrode as viewed from the optical axis direction. FIG. 18D illustrates only a hard substrate including the fixed electrode 113. The reference electrode and the detection electrode described according to the first embodiment are similarly arranged in the fan-like fixed electrode 113 elongated in the circumferential direction along the circumferential direction. The movable electrode 111 and the fixed electrode 113 are arranged so as to face each other while a constant gap is maintained in the optical axis direction. According to the configuration of the present embodiment too, the displacement detection similar to the first embodiment can be performed.

### Modified Example

The preferable embodiments of the present invention have been described above, but the present invention is not limited to these embodiments, and various modifications and alterations can be made within a range of the gist.

For example, according to the respective embodiments, the first electrode (the fixed electrode 13) is arranged in the fixed member (the guide tube 12), and the second electrode (the movable electrode 11) is arranged in the movable member (the MF operating ring 108). It should be noted however that the respective embodiments are not limited to this, and the first electrode may be arranged in the movable member, and the second electrode may be arranged in the fixed member.

According to the present invention, it is possible to provide the displacement detection apparatus in which the power consumption is lower than before and the lens barrel using this, and the imaging apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A displacement detection apparatus comprising:
a first electrode unit including a first detection electrode group including a plurality of first detection electrodes and a second detection electrode group having a phase difference of 180 degrees with respect to the first detection electrode group with regard to a predetermined periodic pattern and also including a plurality of second detection electrodes;
a second electrode unit having a predetermined periodic pattern and including a plurality of second electrodes that is movable relatively with respect to the first electrode unit;
a detection circuit configured to detect an electrostatic capacitance; and
signal processing means for detecting a displacement on the basis of an electrostatic capacitance between the first detection electrode group and the second electrode unit, and an electrostatic capacitance between the second detection electrode group and the second electrode unit, the displacement detection apparatus being characterized in that,
when a state in which an area where the first detection electrode group and the second electrode unit are overlapped with each other becomes the largest is set as a maximum output state,
in the maximum output state, an area where a region in which the first detection electrode group is arranged is overlapped with the second electrode unit is larger than an area where a region in which the second detection electrode group is arranged is overlapped with the second electrode unit,
in the maximum output state, when an electrode facing the region in which the second detection electrode group is arranged among the plurality of second electrodes is set as a first counter electrode,
at least one second detection electrode among the plurality of second detection electrodes is arranged in a manner that a position of a center of the at least one second detection electrode is different from a position of a center of the first counter electrode,
the predetermined periodic pattern of the second electrode unit is a repetitive pattern having a predetermined period in a predetermined direction,
the first electrode unit further includes a reference electrode unit having a length of an integral multiple of the predetermined period in the predetermined direction and being connected to ground, and
the second electrode unit is movable relatively with respect to the detection circuit.

2. The displacement detection apparatus according to claim 1, characterized in that,
when a state in which an area where the first detection electrode group and the second electrode unit are overlapped with each other becomes the smallest is set as a minimum output state, and in the minimum output state, a plurality of electrodes facing the region in which the second detection electrode group is arranged among the plurality of second electrodes are set as a plurality of second counter electrodes,
in the minimum output state,
a center of each of the plurality of second detection electrodes is substantially matched with a center of each of the plurality of second counter electrodes.

3. The displacement detection apparatus according to claim 1, characterized in that,
when a state in which an area where the first detection electrode group and the second electrode unit are overlapped with each other becomes the smallest is set as a minimum output state, in the minimum output state, a plurality of electrodes facing the region in which the second detection electrode group is arranged among the plurality of second electrodes are set as a plurality of second counter electrodes, a deviated amount between a center of each of the plurality of second detection electrodes and a center of each of the plurality of second counter electrodes is set as D1, and a width of each of the plurality of second detection electrodes is set as W1,
in the minimum output state,
0≤D1/W1≤0.1
is satisfied.

4. The displacement detection apparatus according to claim 1, characterized in that,
when a period of the plurality of second electrodes is set as P, and N1 is set as a natural number,
the plurality of second detection electrodes are arranged in a manner that a center-to-center distance of each of the plurality of second detection electrodes becomes N1×P.

5. The displacement detection apparatus according to claim 1, characterized in that,
in the maximum output state,
each of the plurality of second detection electrodes does not face the first counter electrode.

6. The displacement detection apparatus according to claim 1, characterized in that,
when a period of the plurality of second electrodes is set as P, and M1 is set as a natural number,
the first detection electrode group has a length of (M1+0.5)×P in a predetermined direction.

7. The displacement detection apparatus according to claim 1, characterized in that
the first detection electrode group is a first detection electrode pair including two of the first detection electrodes.

8. The displacement detection apparatus according to claim 1, characterized in that,
when a period of the plurality of second electrodes is set as P, and M2 is set as a natural number,
the second detection electrode group has a length of (M2+0.5)×P in a predetermined direction.

9. The displacement detection apparatus according to claim 1, characterized in that
the second detection electrode group is a second detection electrode pair including two of the second detection electrodes.

10. The displacement detection apparatus according to claim 1, characterized in that,
when a state in which an area where the first detection electrode group and the second electrode unit are overlapped with each other becomes the smallest is set as a minimum output state,
in the minimum output state, an area where the region in which the first detection electrode group is arranged is overlapped with the second electrode unit is smaller than an area where the region in which the second detection electrode group is arranged is overlapped with the second electrode unit, and
in the minimum output state, when an electrode facing the region in which the first detection electrode group is arranged among the plurality of second electrodes is set as a third counter electrode,
at least one first detection electrode among the plurality of first detection electrodes is arranged in a manner that a position of a center of the at least one first detection electrode is different from a position of a center of the third counter electrode.

11. The displacement detection apparatus according to claim 1, characterized in that,
in the maximum output state, when a plurality of electrodes facing the region in which the first detection electrode group is arranged among the plurality of second electrodes are set as a plurality of fourth counter electrodes, a center of each of the plurality of first detection electrodes is substantially matched with a center of each of the plurality of fourth counter electrodes.

12. The displacement detection apparatus according to claim 1, characterized in that,
in the maximum output state, when a plurality of electrodes facing the region in which the first detection electrode group is arranged among the plurality of second electrodes are set as a plurality of fourth counter electrodes, a deviated amount between a center of each of the plurality of first detection electrodes and a center of each of the plurality of fourth counter electrodes is set as D2, and a width of each of the plurality of first detection electrodes is set as W2,
in the maximum output state,
0≤D2/W2≤0.20
is satisfied.

13. The displacement detection apparatus according to claim 1, characterized in that,
when a period of the plurality of second electrodes is set as P, and N2 is set as a natural number,
the plurality of first detection electrodes are arranged in a manner that a center-to-center distance of each of the first detection electrodes becomes N2×P.

14. The displacement detection apparatus according to claim 10, characterized in that,
in the minimum output state,
each of the plurality of first detection electrodes does not face the plurality of third counter electrodes.

15. The displacement detection apparatus according to claim 1, characterized in that,
in a direction in which the plurality of second electrodes are aligned,
a length of the region in which the first detection electrode group is arranged is the same length as the region in which the second detection electrode group is arranged.

16. The displacement detection apparatus according to claim 1, characterized in that
the first electrode unit further includes a third detection electrode group provided with a plurality of third detection electrodes and a fourth detection electrode group provided with a plurality of fourth detection electrodes.

17. A lens barrel comprising:
a displacement detection apparatus; and
a lens unit that drives on the basis of a detection result of the displacement by the displacement detection apparatus,
wherein the displacement detection apparatus includes:
a first electrode unit including a first detection electrode group including a plurality of first detection electrodes and a second detection electrode group having a phase difference of 180 degrees with respect to the first detection electrode group with regard to a predetermined periodic pattern and also including a plurality of second detection electrodes;
a second electrode unit having a predetermined periodic pattern and including a plurality of second electrodes that is movable relatively with respect to the first electrode unit;
a detection circuit configured to detect an electrostatic capacitance; and
signal processing means for detecting a displacement on the basis of an electrostatic capacitance between the first detection electrode group and the second electrode unit, and an electrostatic capacitance between the second detection electrode group and the second electrode unit, the displacement detection apparatus being characterized in that,
when a state in which an area where the first detection electrode group and the second electrode unit are overlapped with each other becomes the largest is set as a maximum output state,
in the maximum output state, an area where a region in which the first detection electrode group is arranged is overlapped with the second electrode unit is larger than an area where a region in which the second detection electrode group is arranged is overlapped with the second electrode unit,
in the maximum output state, when an electrode facing the region in which the second detection electrode group is arranged among the plurality of second electrodes is set as a first counter electrode,
at least one second detection electrode among the plurality of second detection electrodes is arranged in a manner that a position of a center of the at least one second detection electrode is different from a position of a center of the first counter electrode,
the predetermined periodic pattern of the second electrode unit is a repetitive pattern having a predetermined period in a predetermined direction,
the first electrode unit further includes a reference electrode unit having a length of an integral multiple of the predetermined period in the predetermined direction and being connected to ground, and
the second electrode unit is movable relatively with respect to the detection circuit.

18. An imaging apparatus comprising:
a lens barrel;
an imaging element; and
a camera main body that holds the imaging element,
wherein the lens barrel includes:
a displacement detection apparatus; and
a lens unit that drives on the basis of a detection result of the displacement by the displacement detection apparatus,
wherein the displacement detection apparatus includes:
a first electrode unit including a first detection electrode group including a plurality of first detection electrodes and a second detection electrode group having a phase difference of 180 degrees with respect to the first detection electrode group with regard to a predetermined periodic pattern and also including a plurality of second detection electrodes;
a second electrode unit having a predetermined periodic pattern and including a plurality of second electrodes that is movable relatively with respect to the first electrode unit;
a detection circuit configured to detect an electrostatic capacitance; and
signal processing means for detecting a displacement on the basis of an electrostatic capacitance between the first detection electrode group and the second electrode unit, and an electrostatic capacitance between the second detection electrode group and the second electrode unit, the displacement detection apparatus being characterized in that,
when a state in which an area where the first detection electrode group and the second electrode unit are overlapped with each other becomes the largest is set as a maximum output state,
in the maximum output state, an area where a region in which the first detection electrode group is arranged is overlapped with the second electrode unit is larger than an area where a region in which the second detection electrode group is arranged is overlapped with the second electrode unit,
in the maximum output state, when an electrode facing the region in which the second detection electrode group is arranged among the plurality of second electrodes is set as a first counter electrode,
at least one second detection electrode among the plurality of second detection electrodes is arranged in a manner that a position of a center of the at least one second detection electrode is different from a position of a center of the first counter electrode,
the predetermined periodic pattern of the second electrode unit is a repetitive pattern having a predetermined period in a predetermined direction,
the first electrode unit further includes a reference electrode unit having a length of an integral multiple of the predetermined period in the predetermined direction and being connected to ground, and
the second electrode unit is movable relatively with respect to the detection circuit.
